(19) United States
(12) Patent Application Publication
(10) Pub. No.: US 2026/0264071 A1
(43) Pub. Date: Sep. 10, 2026

(54) ON-CHIP INTEGRATION OF GENERAL CHEMISTRY, IMMUNO-ASSAY AND HEMATOLOGY

(71) Applicants: Octavian FLORESCU, Carlsbad, CA (US); Ana FLORESCU, Carlsbad, CA (US)

(72) Inventors: Octavian FLORESCU, Carlsbad, CA (US); Ana FLORESCU, Carlsbad, CA (US)

(21) Appl. No.: 19/554,459

(22) Filed: Mar. 2, 2026

Related U.S. Application Data
(60) Provisional application No. 63/767,476, filed on Mar. 5, 2025.

(51) Int. Cl. B01L 3/00

(52) U.S. Cl. CPC B01L 3/502; B01L 2200/0647; B01L 2200/16; B01L 2300/0681; B01L 2300/161

(57) ABSTRACT

The single-use disposable described herein can measure one or more blood chemistry analytes, immuno-assay analytes and a hematology measurement from a drop of whole blood. A passive filtration system takes whole blood and delivers plasma along with a dissolved reporter molecule to one or more spectrophotometers which can operate with narrow band optical spectrum centered on an optical detection frequency. The spectrophotometer detects the changes in absorption of the plasma as a result of a chemistry reaction to determine the concentration or activity of one or more analytes. Plasma can also be delivered to a magnetic particle detector chip that can perform magnetic separation and detection of magnetic particles to measure an immuno-assay biomarker. Whole blood can be delivered to a hematology capillary in which cells can be counted optically.

### CROSS-REFERENCE TO RELATED APPLICATION

The present application claims priority to U.S. provisional application 63/767,476 filed Mar. 5, 2025 which is incorporated by reference herein in its entirety.

### TECHNICAL FIELD

The present disclosure relates to single-use, disposable, digital biosensors and integrated circuit-based biosensors for use with whole blood

### BACKGROUND

Chemistry, immuno-assays and hematology measurements can measure the number, quality, concentration or activity of one or more target analytes, i.e., endogenous compounds circulating in blood. These analytes can be small molecules such as ions, blood gases, electrolytes, metabolites, amino-acids, supplements and nutrients or large molecules like antibodies, peptides and enzymes or cells. Examples of general chemistry biomarkers can include albumin, blood urea nitrogen, uric acid, calcium, carbon dioxide (bicarbonate), chloride, creatinine, glucose, potassium, sodium, magnesium, phosphorus, lactate, amylase, lactate dehydrogenase, direct bilirubin, total cholesterol, high-density lipoprotein cholesterol, triglycerides, total bilirubin, total protein, creatine kinase, alanine aminotransferase (ALT), alkaline phosphatase (ALP), aspartate aminotransferase (AST) and gamma glutamyltransferase. Examples of immuno-assay biomarkers include C-reactive protein, troponin, B-type natriuretic peptide, D-dimer, pregnancy and fertility indicators. Examples of hematology biomarkers include red blood cell count, hematocrit, mean corpuscular volume, mean corpuscular hemoglobin, mean corpuscular hemoglobin concentration, red cell distribution width, white blood cell count, white blood cell differential, platelet count, prothrombin time, the presence of DOACs and others.

The results from general chemistries, immuno-assays and complete blood count tests can be critically time sensitive, yet the instruments capable of performing such measurements are often relegated to emergency departments and central laboratories and require burdensome calibration and maintenance.

This blood analysis system can perform a general chemistry biomarker measurement with less than 10 μL of whole blood, an immuno-assay biomarker measurement on with less than 10 μL of whole blood, and a hematology biomarker measurement with less than 10 μL of whole blood. This blood analysis system can perform a general chemistry biomarker measurement, an immuno-assay biomarker measurement and a hematology biomarker measurement simultaneously from a single drop of blood.

### SUMMARY

A spectrophotometer, a magnetic sensing IC and a hematology system can be miniaturized and integrated into a single-use disposable. Users can place a sample of whole blood from a finger-stick or venipuncture on the inlet cuvette of the disposable. A reader can be used to perform hematology measurements.

The spectrophotometer can have a variety of features: 1) the detection can be performed on undiluted samples, 2) the path length can be shorter than in conventional spectrophotometers, 3) the illumination can be from an LED emitting light with a narrow band optical spectrum, 4) the reflector can be made from injection molded plastic, 5) the reagents can be stored in a dry state in the disposable and 6) there can be at least one photodiode per well, 7) the spectrophotometer can be integrated into a single-use disposable, and 8) the spectrophotometer can cancel offsets from interferers and background opacity.

The magnetic sensing IC can generate the magnetic forces to remove non-specifically bound magnetic particles and detect the remaining specifically bound ones.

The hematology system can use an imaging system to count blood cells assembled in one or more monolayers between a top and bottom slide.

The single-use disposable can have a single inlet cuvette that can be fluidically connected to the spectrophotometer, the magnetic sensing IC and the hematology capillary. One or more filters can block red blood cells but can allow plasma to flow into the spectrophotometer or onto the surface of magnetic sensing IC. The magnetic sensing IC can have an array of optical sensors. One or more LED can illuminate a photodiode in the spectrophotometer or an optical sensor in the magnetic sensing IC. The inlet cuvette can accept a drop of blood when the single use disposable is inserted into the reader.

### BRIEF DESCRIPTION OF THE DRAWINGS

FIG. 1 presents the cross-sectional side view of disposable 1 with well 19 filled with plasma 17. Critical reagent 160 can be dried on protrusion 50 and can dissolve in plasma 17 in well 19.

FIG. 2 presents the cross-sectional side view of disposable 1 comprising a inlet cuvette with a hydrophobic portion 142 and a drop pin 143.

FIG. 3 presents the cross-sectional side view of magnetic particle 98 that can sediment to the surface of the magnetic sensing IC 83. Magnetic particle 98 and magnetic sensing IC 83 can be illuminated by LED cluster 130.

FIG. 4 presents a pipette 220 with a stand 221 that can hold pipette 220 in a vertical position.

### DETAILED DESCRIPTION

Spectrophotometer 15 can be an absorption spectrophotometer, wherein light 21 can traverse through plasma 17 and wherein reporter molecule 56 can absorb part or all of light 21 traversing through plasma 17. Spectrophotometer 15 can be a reflectance spectrophotometer, wherein light 21 reflects off plasma 17 and wherein reporter molecule 56 can absorb part or all of light 21 reflecting off plasma 17. Spectrophotometer 15 can be a single frequency spectrophotometer. Spectrophotometer 15 can operate using a narrow band optical spectrum, centered at optical detection frequency 60. Spectrophotometer 15 can be configured to measure the concentration or activity of analyte 36 in plasma 17. Spectrophotometer 15 can be configured to measure the absolute or rate of change of the absorption of plasma 17 in well 19 at the optical detection frequency 60. Spectrophotometer 15 can be configured to measure the rate of or absolute change in the absorption of reporter molecule 56 in plasma 17 in well 19 at the optical frequency 60. Spectrophotometer 15 can comprise a surface capillary 22 that can fluidically connect filter 2 or surface 11 with well 19. Spectrophotometer 15 can comprise a light emitting diode (LED) 5 capable of emitting light 21 with a peak frequency at optical detection frequency 60. LED 5 can be capable of emitting light 21 with a narrow band optical spectrum. Spectrophotometer 15 can comprise a reflector 6 capable of redirecting light 21 at a detection frequency 60 through plasma 17 in well 19 and onto photodetector 8. Reflector 6 can be configured to redirect light 21 at a detection frequency 60 through plasma 17 normal to the detection plane of photodetector 8. Spectrophotometer 15 can comprise a photodetector 8 that can be sensitive to light 21 at a detection frequency 60. Photodetector 8 can be capable of measuring the change over time of the transmittance of plasma 17 in well 19 at detection frequency 60, resulting from the change over time of the concentration of reporter molecule 56 in plasma 17 in well 19, corresponding to the concentration or activity of analyte 36 in plasma 17 in well 19. Photodetector 8 can be capable of measuring the change over time of the transmittance of plasma 17 in well 19 at detection frequency 60, resulting from the change over time of interferences or opacity. Photodetector 8 can be capable of measuring the change over time in the transmittance of reporter molecule 56 in plasma 17 in well 19 at detection frequency 60.

Single-use disposable 1 can analyze a variety of sample types such as whole blood, plasma, serum, plasma products, calibrators, purified solutions, tears, saliva and urine. Disposable 1 and spectrophotometer 15 can analyze aqueous samples in well 19. Disposable 1 can measure the plasma concentration of general chemistry biomarkers like albumin, blood urea nitrogen, uric acid, calcium, carbon dioxide (bicarbonate), chloride, creatinine, glucose, potassium, sodium, magnesium, phosphorus, lactate, amylase, lactate dehydrogenase, direct bilirubin, total cholesterol, high-density lipoprotein cholesterol, triglycerides, total bilirubin, total protein, creatine kinase, alanine aminotransferase (ALT), alkaline phosphatase (ALP), aspartate aminotransferase (AST) and gamma glutamyltransferase, and other analytes. An analyte can also be referred to as an endogenous compound.

Disposable 1 can measure the plasma concentration of immune-assay biomarkers like C-reactive protein, troponin, B-type natriuretic peptide, D-dimer, pregnancy, fertility indicators and others.

The blood analysis system can include a disposable 1 and a reader 100. The blood analysis system can measure whole blood hematology biomarkers like red blood cell count, hematocrit, mean corpuscular volume, mean corpuscular hemoglobin, mean corpuscular hemoglobin concentration, red cell distribution width, white blood cell count, white blood cell differential, platelet count, prothrombin time, the presence of DOACs and others.

The optical detection frequency 60 can be 340 nm, 405 nm, 467 nm, 510 nm, 525 nm, 550 nm, 590 nm, 600 nm, 630 nm, 850 nm or other frequencies. Spectrophotometer 15 can comprise a plurality of wells, through which light 21 can travel to a plurality of photodetectors. Spectrophotometer 15 can contain a single reflector 6 and a single LED 5, wherein reflector 6 has the necessary optical elements to split light 21 from a single LED 5 and redirect the split light through a plurality of wells onto a plurality of photodetectors. Each well can be above, below, adjacent, abutted or in proximity to a dedicated photodetector. Spectrophotometer 15 can have a plurality of wells, wherein each well can be adjacent to a single photodetector. Disposable 1 can comprise a single filter 2 and a plurality of wells, such that plasma 17 from whole blood 16 can flow passively from filter 2, across one or more surfaces into a plurality of wells. A plurality of spectrophotometers can share a single filter, such that plasma 17 from whole blood 16 can flow passively from filter 2 into a plurality of wells in a plurality of spectrophotometers. Disposable 1 can comprise one or more surfaces that can fluidically connect one or more filters to one or more wells in one or more spectrophotometers. Disposable 1 can comprise a plurality of spectrophotometers, wherein the plurality of spectrophotometers can operate at different frequencies of detection. A plurality of spectrophotometers can share a single IC 9 or AOW 4.

### Reaction

Chemical reaction 35 can be composed of multiple reactions. Chemical reaction 35 can be homogeneous and label-free. Chemical reaction 35 can be an immuno-assay reaction, Chemical reaction 35 can include magnetic particles. Chemical reaction 35 can be limited by the concentration or activity of analyte 36 in plasma 17 in well 19. For chemical reaction 35 to be limited by the concentration or activity of analyte 36, the concentration or activity of analytes 36 can be the rate limiting reagents in chemical reaction 35 or the concentration or activity of analytes 36 can be the endpoint limiting reagents in chemical reaction 35. Reporter molecule 56 can be a product or reactant to chemical reaction 35. Reporter molecule 56 can be endogenous in sample 18. Reporter molecule 56 can be analyte 36. Reporter molecule 56 can be in excess in chemical reaction 35 wherein reporter molecule 56 may not be the rate limiting reagent. Dissolved reagents 33 can be in excess in plasma 17 such that chemical reaction 35 can be limited by the concentration or activity of analyte 36. Reporter molecule 56 or reporter reagent can be a molecule that can absorb light with a linear extinction coefficient, whereby changes in the concentration of reporter molecule 56 can be calculated using Beer-Lambert's law. Reporter molecule 56 can absorb light at the optical detection frequency 60. Reporter molecule 56 can have an absorption peak at the optical detection frequency 60.

Chemical reactions 35 can be a zero-order, pseudo-zero order, a first order or a higher order chemical reaction. In a rate measurement, the rate of reporter molecule 56 consumed or produced can be measured. This rate can be proportional to concentration or activity of one or more analytes in plasma 17. In an endpoint measurement, the total amount of reporter 8 molecule 56 consumed or produced can be measured. This amount can be proportional to a physiological concentration or activity of one or more analytes.

Chemical reaction 35 can alter the absorption of plasma 17 in well 19 at the optical detection frequency 60. Chemical reaction 35 can alter the concentration of reporter molecule 56 in plasma 17 in well 19. The change in concentration of reporter molecule 56 in plasma 17 in well 19 can change the absorption of plasma 17 in well 19 at the optical frequency of detection 60. By measuring light absorption of plasma 17 in well 19 from the LED 5 at two different time points, and accounting for the time elapsed, a rate or endpoint measurement of reactions 35 can be calculated.

Surface 11 can be coated with surface reagents 30. Surface 11 can be adjacent to gap 12 and can be coated with a hydrophilic reagent 31, such as surface reagents 30. Filter 2 can be coated or impregnated with filter reagents 32. Well 19 can be coated on the inside with well reagents 34. The bottom surface of AOW 4 can be coated with surface reagents 30 or well reagents 34. Additional reagents 37 can be dried in the form of a dried sphere 38. The dried sphere 38 can be placed at the top of well 19, at the bottom of well 19, inside well 19, below filter 2, above filter 2, next to filter 2, or in gap 12. The dried sphere 38 can be manufactured through lyophilization. The diameter of the dried sphere 38 can be less than 2 mm, 1.5 mm, 1 mm, 0.75 mm, 0.5 mm, 0.4 mm, 0.3 mm, 0.2 mm, or 0.1 mm. The dried sphere 38 can dissolve when contacted with fluid, such as the plasma 17. All the reagents can be stored dry in disposable until re-hydrated by plasma 17.

Chemical reaction 35 can consist of one or a plurality of initiator molecules 200. Initiator molecule 200 can initiate chemical reaction 35. Initiator molecule 200 can be a product or reactant to chemical reaction 35 or an enzyme or a catalyst in chemical reaction 35 or a cross-linker in chemical reaction 35. Initiator molecule 200 can initiate, facilitate or accelerate chemical reaction 35. Initiator molecule 200 can be dried on the surface of protrusion 50, lens 51 or on emitter surface 201. The initiator molecule 200 can also be dried in well 19, on surface capillary 22, on surface 11 or in filter 2. The critical reagents can include the initiator molecule.

In a dissolved state, initiator molecule 200 can be transparent or nearly transparent to light 21 at the optical frequency 60. In a dissolved state, initiator molecule 200 can transmit more than 50% of light 21 at the optical frequency 60. In a dissolved state, initiator molecule 200 can transmit less than 50% of light 21 at the optical frequency 60.

In a dry state, initiator molecule 200 can be opaque or nearly opaque to light 21 at the optical frequency 60. In a dry state, initiator molecule 200 can transmit more less 50% of light 21 at the optical frequency 60. In a dry state, initiator molecule 200 can transmit more than 50% of light 21 at the optical frequency 60.

A drop of whole blood 16 from a fingerstick or venous whole blood draw can be applied on filter 2. The whole blood 16 can mix with filter reagents 32. Filter 2 can trap the blood cells in whole blood 16 and let pass through plasma 17. Plasma 17 can mix with filter reagents 32. Plasma 17 can flow from filter 2 onto surface 11. Plasma 17 can wick or sheet on surface 11, across gap 12, within slot 25. Hydrophilic reagent 31 can promote plasma 17 sheeting or wicking across gap 12 into surface capillary 22. Surface capillary 22 can be formed between the AOW 4 and surface 11, or between the IC 9 and surface 11. Plasma 17 can mix with surface reagent 30. Surface capillary 22 can connect to well 19 such that Plasma 17 can flow from surface capillary 22 and into well 19. Plasma 17 can flow up or down well 19 due to capillary action and can cease to flow once it reaches the opposite side of well 19. Plasma can contact lens 51 or protrusion 50 and excess plasma can vent through vent 52. A vent 52 can be an air channel that lets air pass through.

Reporter molecule 56 can be included in surface reagents 30, hydrophilic reagents 31, filter reagents 32, well reagents 34, or additional reagents 37. Plasma 17 can mix with or dissolve dried reporter molecule 56 surface reagents 30, hydrophilic reagents 31, filter reagents 32, prefilter reagents, well reagents 34 and additional reagents 37. Reporter molecule 56, surface reagents 30, hydrophilic reagents 31, filter reagents 32, well reagents 34, or additional reagents 37 can combine or dissolve into dissolved reagents 33 in plasma 17. Reporter molecule 56, surface reagents 30, hydrophilic reagents 31, filter reagents 32, well reagents 34, or additional reagents 37 can dissolve upon contact with plasma 17.

The dissolved reagents 33 in plasma 17 can participate in or initiate chemical reaction 35 in plasma 17 in well 19. Initiation of chemical reaction 35 can alter the plasma absorption of plasma 17 in well 19 at an optical detection frequency 60.

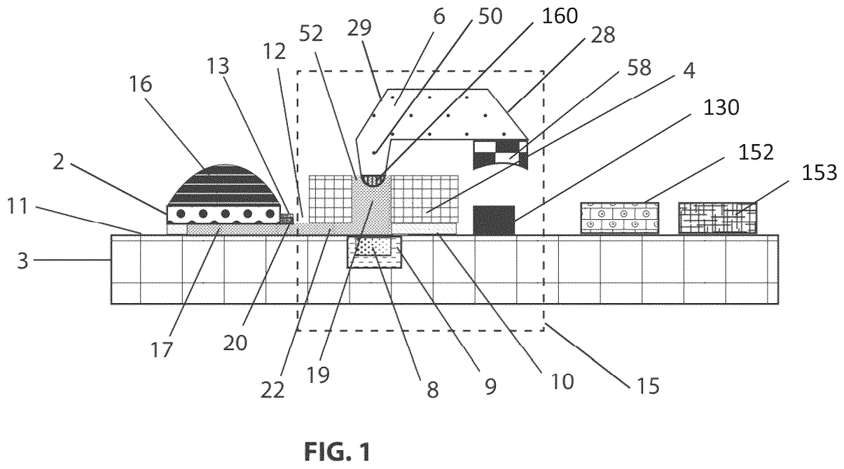

Disposable 1 can be configured to perform two multiplexed chemistry tests. A chemistry test that can have medical relevance is alanine aminotransferase (ALT) and aspartate aminotransferase (AST). The design in FIG. 1 can be configured so that ALT and AST measurements are performed separately and concurrently in well 19 and well 7, respectively. ALT can be performed using Filter 2, on surface 11 inside channel 25 and in well 19. AST can be performed using filter 55, on surface 11 inside channel 23 and in well 7. The chemical reactions for measuring ALT and AST are two examples of chemical reaction 35.

The chemical reaction for measuring ALT can comprise 1) ALT in plasma catalyzing the transfer of an amino group from L-alanine to alpha-ketoglutarate to form L-glutamate and pyruvate, and 2) lactate dehydrogenase (LDH) catalyzing the conversion of pyruvate to lactate and the oxidation of Nicotinamide adenine dinucleotide (NADH) to NAD+. The chemical reaction for measuring AST can comprise 1) AST catalyzing the conversion of L-aspartate and alpha-ketoglutarate into oxaloacetate and L-glutamate, and 2) Malate dehydrogenase (MDH) catalyzing the conversion of oxaloacetate into malate and the oxidation of NADH to NAD+. The reagent substrates for measuring AST and ALT can be introduced in abundance so the rate of the chemical reactions can be limited by the rate of endogenous AST and ALT in the plasma 17, respectively. The reporter molecule 56 for both ALT and AST reactions can be NADH. NADH has a narrow band absorptions spectrum centered on 340 nm, so the amount or rate of NADH consumed in the chemical reactions can be measured by illuminating the wells 19 and 7 with light from an LED 5 emitting light 21 with a narrow band optical spectrum with an optical detection frequency of 340 nm. Reflector 6 can redirect light 21 from LED 5 into both wells 7 and 19. In a rate measurement, the rate of change of the absorption at 340 nm can be due to the conversion of NADH to NAD+ and can be proportional to the amount of ALT or AST present in the plasma 17. Photodetector 8 can measure the change in the amount of light transmitted through the plasma 17 in well 19 over time, and can determine from calibration values stored on the IC 9 the corresponding concentration of endogenous ALT and AST.

Filter reagents for filter 2 for ALT can comprise dried 1-alanine, NADH, alpha-ketoglutarate, LDH and excipients. The surface reagents for ALT can comprise 1-alanine, NADH, alpha-ketoglutarate, LDH and excipients. The well reagents for ALT can comprise hydrophilic reagents to maximize the capillary force, 1-alanine, NADH, alpha-ketoglutarate, LDH and excipients. The additional reagents for ALT can comprise 1-alanine, NADH, alpha-ketoglutarate, LDH and excipients.

Filter reagents for filter 55 for AST can comprise dried l-aspartate, NADH, alpha-ketoglutarate, MDH and excipients. The surface reagents for AST can comprise l-aspartate, NADH, alpha-ketoglutarate, MDH and excipients. The well reagents for AST can comprise hydrophilic reagents to maximize the capillary force, 1-aspartate, NADH, alpha-ketoglutarate, MDH and excipients. The additional reagents for AST can comprise 1-aspartate, NADH, alpha-ketoglutarate, MDH and excipients.

The ALT chemical reaction can be confined to well 19 by applying the ALT reagents exclusively to filter 2, on surface 11 inside channel 25 or in well 19. The AST chemical reaction can be confined to well 7 by applying the AST reagents exclusively to filter 55, on surface 11 inside channel 23 or in well 7.

To measure bilirubin in plasma 17, the initiator molecule 200 can be bilirubin oxidase. The reporter molecule 56 can be endogenous to plasma 17. The reporter molecule 56 can be bilirubin. The detection frequency 60 for bilirubin can be 467 nm, or 550 nm or other frequency.

Whole blood 16 can be applied to both filter 2 and filter 55 simultaneously. The chemical reactions in wells 19 and 7 can be measured concurrently or at different times. 22

ALT and AST are both examples of chemical reaction 35 where a rate measurement can be proportional to the activity of ALT and AST in whole blood 16. Chemical reaction 35 can be a rate reaction wherein the measurement can be performed in a single well 19.

Chemical reaction 35 can be an endpoint reaction, wherein the measurement can be performed in two wells, namely well 19 and well 7. Well 19 can be used to measure the concentration of reporter molecule 56 produced or consumed, while well 7 can be used to measure the concentration of reporter molecule 56 prior to any consumption or production. The dissolved reagents in well 7 can omit a key reagent necessary for chemical reaction 35, wherein the reporter molecule 56 in well 7 can be neither consumed nor produced.

The dominant source of noise in an ALT assay can be the natural oxidation of NADH into NAD+ by endogenous reactions other than chemical reaction 35. Well 7 can be used as a blank well to measure the natural oxidation of NADH, or other blank measurement. The blank measurement can be subtracted from the chemical reaction 35 in well 19, or from other chemistry reaction measurements, to eliminate the contribution of the natural oxidation of NADH or other sources of noise. L-alanine can be omitted from the dissolved reagents, such that chemical reaction 35 cannot run in well 7 and only the blank measurement can be made in well 7. In the case of ALT, NADH can be dried in Filter 2 that can be shared between the 8 measurement wells 7 and 19. Blank wells can be used to measure interfering substances that can change the absorption of the plasma during run time of the assay.

Disposable 1 can contain a blank filter 55 which can produce plasma 17 without reporter molecule 56. Disposable 1 can contain a blank well 7 which can accumulate plasma 17 produced by blank filter 55, to measure the absorption of plasma 17 without reporter molecule 56, or blank measurement. The blank measurement can be used to determine the concentration of reporter molecule 56 dissolved in plasma 17, or the intrinsic absorption of plasma 17 or both. The blank measurement can be subtracted from the absorption measurements in other wells. The blank measurement or NADH-blank measurement can be combined to measure endpoint reactions by providing the concentration of the reporter reagent 56 before and after reaction 35 occurs.

The optical detection frequency 60 of the emission of the LEDs 5 can be selected to correspond to the spectral absorbance peak of analyte 36 that yields the highest signal to noise ratio.

A plurality of wells can contain plasma with a plurality of dissolved reagents, wherein the dissolved reagents in one well can be different from the next well. A plurality of wells can be illuminated with light with a plurality of optical detection frequencies, wherein the optical detection frequencies in one well is different from the optical detection frequency of the next. A plurality of wells can receive plasma from a shared filter. Some wells can be used as blanks, wherein chemical reaction 35 may not proceed. The results from blank wells can be combined with the results from analyte measurement wells, wherein the concentration or activity of an analyte is measured.

Disposable 1 can perform a turbidity assay wherein the presence or absence of the analyte 36 can cause a cross-linking or stop a cross-linking reaction in plasma 17 in well 19. A cross-linking reaction can change the opacity of plasma 17 in well 19. Cross-linking reaction can increase or reduce the opacity of the plasma 17 in well 19. The opacity of well 19 can be elevated due to a cross-linking reaction involving analyte 36. Cross-linked species including the analyte can block or transmit light at optical frequency 60. The cross-linker can initiate or drive, modulate or accelerate the cross-linking reaction. The cross-linker can be an antibody, aptamer, oligonucleotides, amino-acids, a metal, polysaccharides or other reactive species. Chemical reaction 35 can be a cross-linking reaction. The amount of cross-linking can correspond to the opacity of plasma 17 at optical frequency 60. The reporter molecule 56 can be the cross-linked molecule. The cross-linker can be in a dry state in the dried critical reagents on the tip of protrusion 50 to avoid premature initiation of the cross-linking reaction. The cross-linker can be the initiator molecule 200. The cross-linking reaction can be initiated in well 19 filled with plasma 17 when critical reagents are dissolved. Well 19 can be full of plasma 17 prior to initiation of the cross-linking reaction. Disposable 1 can be configured to measure the complete or absolute change in the opacity of the plasma 17 in well 19 from the cross-linking reaction involving the cross-linker.

Critical reagents 160 can include enzymes needed for chemical reaction 35. Critical reagents 160 can include reactants or products of chemical reaction 35. Critical reagents 160 can include a competitive inhibitor, linear inhibitor or any other inhibitor that increases the Michaelis constant or decreases the activity of an enzyme. Critical reagents 160 can include co-factors or reagents that increase the activity of an enzyme. A competitive inhibitor or co-factor can be dried in the filter module or well 19.

### Analyte Measurement

Spectrophotometer 15 can comprise an integrated circuit (IC) 9 that can integrate or embed one or more photodetectors, namely photodetector 8. IC 9 can integrate a calculation circuit that can calculate an absorption measurement from a transmittance measurement. The calculation circuit can calculate the rate of or absolute change of the absorption of reporter molecule 56 in plasma 17 in well 19 from the rate of or absolute change in the transmittance of reporter molecule 56 in plasma 17 in well 19. The calculation circuit can calculate the rate of or absolute change of the absorption of plasma 17 in well 19 from the rate of or absolute change in the transmittance of plasma 17 in well 19. The calculation circuits can calculate the ratio of serial measurements of transmittance. The calculation circuits can perform the logarithmic function in a base, such as 2, e, 8, 10, 16 or any other. The calculation circuits can perform the inverse logarithmic function, i.e. the exponential function in a base such as 2, e, 8, 10, 16 or any other. The calculation circuits can calculate the concentration or activity of analyte 36 in plasma 17 in well 19 using Beer-Lambert's law and serial measurements of the absorption or serial measurements of transmittances of plasma 17, the nominal path length in well 19, the elapsed time between serial measurements and the extinction coefficient of reporter molecule 56. The calculation circuits can calculate the concentration of analyte 36 in plasma 17 in well 19 from serial transmittance or absorption measurements from a control well. Calculation circuits can be arithmetic a logic unit (ALU), a digital signal processor (DSP) or a look-up table, or a combination thereof. Stored information stored or encoded in disposable 1 can be stored or encoded in volatile or non-volatile memory integrated in IC 9 or in a separate memory chip 153 electrically connected to IC 9. Stored information can store or encode the nominal path length of well 19 and the extinction coefficient of reporter molecule 56.

Disposable 1 can be configured to perform endpoint reaction measurements using a single well 19. Disposable 1 can be configured to perform a background measurement of the 19 plasma 17 in well 19 before chemical reaction 35 initiates, or before a majority of chemical reaction 35 initiates, or before chemical reaction 35 terminates.

Critical reagents 160 can be dissolved in plasma 17 in well 19 when chemical reaction 35 is uninitiated, or when chemical reaction 35 is incomplete, or when chemical reaction 35 is in progress. Dissolved critical reagents 160 can be concentrated, located or relegated to one portion or side of well 19 full with plasma 17. Dissolved critical reagents 160 can be distributed in a gradient in well 19 with plasma 17. Disposable 1 can be configured to measure the background opacity of plasma 17 after dissolved critical reagents 160 are dissolved in plasma 17 but before dissolved critical reagents 160 have diffused uniformly throughout the entire well 19 and initiated chemical reaction 35. Disposable 1 can be configured so the background opacity of plasma 17 can be measured when critical reagents 160 are dissolved in plasma 17 but before dissolved critical reagents 160 have diffused uniformly throughout well 19. Disposable 1 can be configured so the opacity of plasma 17 can be measured when critical reagents 160 are dissolved in plasma 17 but before the concentration of reporter molecule 56 hasn't changed by more than 0.1%, 1%, 5%, 10%, 20% or 50% as a result of chemical reaction 35. Critical reagent 160 can be dried on protrusion 50 and can dissolve in plasma 19 in well 19. The concentration of the dissolved critical reagent 160 can differ in plasma 17 in well 19. The concentration of the dissolved critical reagent 160 can be higher next to protrusion 50.

Disposable 1 can be configured to subtract the background opacity measurement of plasma 17 in well 19 from the fully reacted opacity measurement of plasma 17 in well 19. The fully reacted opacity measurement can be the measured opacity of plasma 17 in well 19 after reaction 35 terminates. The fully reacted opacity measurement can be the measured opacity of plasma 17 in well 19 after the assay time has ended. Chemical reaction 35 can be a reaction initiated by initiator molecule 200 and limited by the quantity or activity of analyte 36.

### Path Length Control

Path length 39 can be the distance traveled by light 21 from LED 5 through plasma 17 in well 19. Different rays of light 21 can travel a plurality of paths through plasma 17 in well 19. Path length 39 can be the mean of the distribution of the distances the different rays of light 21 traveled through plasma 17 in well 19. Path length 39 can be less than 5 mm, 4 mm, 3 mm, 2 mm, 1.5 mm, 1.25 mm, 1 mm, 0.75 mm, 0.6 mm, 0.5 mm, 0.4 mm, 0.3 mm, 0.25 mm. The coefficient of variance of the distribution of the distances the different rays of light 21 traveled through plasma 17 in well 19, can be less than 50%, 25%, 15%, 10%, 9%, 8%, 7%, 6%, 5%, 4%, 3%, 2% or 1%. For a disposable 1 with a plurality of wells, the path lengths for each well can differ.

A nominal path length is a length that can be calculated from design specifications and measurements to estimate the actual path length 39. The path length 39 in disposable 1 is generally much shorter than traditional quantitative spectrophotometers. So small manufacturing tolerances can greatly affect path length 39. The nominal path length of well 19 can be different from the actual path length 39 as a result of manufacturing tolerances. This difference between the actual path length 39 and the nominal path length can impact the performance of spectrophotometer 15. The nominal path lengths for each well or aspects of the nominal path length for each well can be measured individually or in combination during manufacturing and can be stored in the stored information. Aspects of the nominal path length that can be measured individually or in combination during manufacturing can include the depth of well 9, the thickness of tape 10, the profile of reflector 6, the profile of protrusion 50, the profile of lens 51, the co-planarity of IC 9 and surface 11, the position of LED 5 on PCB, the relative position of LED 5 with respect to reflector 6, the relative position of LED 5 with respect to well 19, and the relative position of reflector 6 with respect to well 19 or incident angle of light 21 on the detection plane of photodetector 8. Multiple aspects of the nominal path length can be combined mathematically or measured at once. The nominal path length can be a combination of one or more aspects of the nominal path length. The nominal path length can vary from the actual path length 39 by a path length error less than 20%, 15%, 10%, 9%, 8%, 7%, 6%, 5%, 4%, 3%, 2% or 1%.

Light scattering off the walls of well 19 can widen the distribution of the distances traveled by the rays of light 21 and therefore affect the path length error. The construction of well 19 and photodetector 8 can be configured to avoid or reduce detection of light 21 scattering off the walls of well 19. Photodetector 8 can be inset to the aperture of well 19 in proximity to photodiode 8 to reduce or eliminate the detection of light 21 scattering off the walls of well 19. The construction of well 19 and photodetector 8 can be configured to avoid or reduce light 21 scattering off the walls of well 19. The sidewalls of well 19 can have a draft angle of 1°, 2.5°, 5°, 10°, 12.5°, or 15°, wherein well 19 widens in the direction of photodetector 8. The draft angle can reduce or eliminate the scattering off the walls of well 19 of rays of light 21 that radiate out from reflector 6 and are not normal, i.e. not perpendicular, to the plane of photodetector 8.

Light 21 from LED 5 can be redirected by reflector 6 such that light 21 is incident normal or oblique to the plane of photodetector 8 or surface 11. For superior path length 39 control, light 21 can be incident normal to the plane of photodetector 8 or surface 11 so that stray rays at oblique angles can accrue minimal additional path length error by the combination of symmetry and trigonometry of small angles.

Another large source of path length error is the air-plasma interface at the top of well 19. The plasma meniscus at the top of well 19 can expand, contract or change shape at run time depending on the volume of plasma 17 extracted by filter 2. Protrusion 50 can contact the plasma 17 at the top of well 19 such that light 21 can travel directly from reflector 6 into plasma. Light 21 can avoid traversing the air-plasma interface.

### Narrow Band Optical Spectrum

Optical detection frequency 60 can be the peak frequency of a narrow band optical spectrum. A narrow band optical spectrum can be an optical spectrum with frequency peak and Full Width Half Maximum (FWHM) of less than 200 nm, 100 nm, 50 nm, 25 nm, 20 nm, 15 nm, 10 nm, 5 nm, 4 nm, 3 nm, 2 nm or 1 nm.

### Optical Filter

Light 21 emitted from LED 5 can have a broad spectrum with no or small peak frequency. Light 21 can be white light. To achieve operation with a narrow band optical spectrum at a single frequency, spectrophotometer 15 can contain an optical filter 80. An 11 optical filter 80 can have an optical passband at the optical detection frequency 60. The passband bandwidth of optical filter 80 can be less than 200 nm, 100 nm, 50 nm, 25 nm, 20 nm, 15 nm, 10 nm, 5 nm, 4 nm, 3 nm, 2 nm or 1 nm. Optical filter 80 can be placed on or near photodetector 8, IC 9, inlet of reflector 6, lens 58 of reflector 6, lens 51, protrusion 50, reflector 6, LED 5, lens 57. Optical filter 80 can be placed in the path traveled by light 21 between LED 5 and photodetector 8. Optical filter 80 can be coated on photodetector 8, IC 9, inlet of reflector 6, lens 58 of reflector 6, lens 51, protrusion 50, reflector 6, LED 5, lens 57. Disposable 1 can contain a plurality of spectrophotometers with optical filters having the same or different optical passbands.

### Integrated Circuit

IC 9 can be a Complementary Metal Oxide Semiconductor (CMOS) IC. IC 9 can comprise a photodetector 8 electrically connected to a charge integrator such as a capacitor. Photodetector 8 can produce a photocurrent that is proportional to the light incident on the surface of photodetector 8. The photocurrent can charge or discharge the charge integrator. The charge integrator can be connected to an amplifier or a comparator embedded on IC 9. The IC 9 can generate a first reference voltage that can be used as a comparison trigger for the comparator. IC 9 can drive a current through LED 5. IC 9 can pre-charge the charge integrator to a second reference voltage. IC 9 can drive current through LED 5 and measure the integration time until the charge integrator voltage reaches the first reference voltage and triggers the comparator. The integration time can be the time elapsed from when the charge integrator is no longer pre-charged until the comparator is triggered and switches state. The charge integrator voltage or input of the comparator can be chopped to minimize 1/f noise. The input of the comparator can be inverted. The average integration time can be the average between the two integration times with the comparator inputs in the inverted and non-inverted states. The average integration time can correspond to the radiant flux of light from LED 5 incident on photodetector 8, and by extension corresponds to the concentration or activity of analytes 36 being measured. IC 9 can make one or more time resolved plasma absorption measurements of the absorption of plasma 17 in well 19 before, during or after reactions 35.

IC 9 can integrate a microcontroller or microprocessor to control the state of disposable 1, memory to store calibration data and results, a power management unit to drive the LEDs and sink power from the battery 40. IC9 can integrate a boost converter or a power converter to increase the supply voltage above what the batteries 40 can supply. By integrating a boost converter, the supply voltage for IC 9, LED 5 and display 41 can be boosted up and disposable 1 can run off a single battery 40. Disposable 1 can sink less than 20 mA, or less than 10 mA or less than 5 mA or less than 2 mA or less than 1 mA or less than 0.5 mA from battery 40.

### Temperature Control

Temperature is an important factor that can alter the optical power emitted by LED 5, the sensitivity of photodetector 8 or the activity of enzymes or other reagents in reactions 35. IC 9 can integrate one or more temperature sensors to measure the temperature of IC 9, surface 11, plasma 17, LED 5 or the ambient temperature inside disposable 1. Temperature sensors can be any electronic disposable with deterministic temperature coefficients, such as bipolar junction transistors (BJT), diodes, bandgap or resistors. The one or more temperature sensors 22 can be calibrated during manufacturing using a single point manufacturing temperature calibration or a multi-point temperature calibration. The temperature sensors can be soaked and calibrated at manufacturing temperature during manufacturing. The Manufacturing temperature can be equal to the run time heater temperature, such as 25C, 30C, 35C, 36C, 37C, 38C, 39C or 40C. Run time can be defined as the time when disposable 1 is activated. The one or more temperature sensor calibration values and algorithms to combine them with run time temperature measurements can be stored in memory on IC 9. Temperature sensor calibration values can be combined with run time temperature measurements from temperature sensors to provide accurate temperature measurements. Calibrated run time temperature measurements can be accurate to within 2C, 1C, 0.5C, 0.25C or 0.1C of actual temperatures. LED 5, BJTs integrated in IC 9, and resistors integrated in IC 9 can be temperature sensors. The calibration measurements from temperature sensors can be used to mathematically compensate the plasma absorption measurements for temperature changes at run time or differences between run time temperature and manufacturing temperature.

IC 9 can integrate a bandgap or other circuits to generate currents with or without temperature compensation. The current through LED5 can be temperature compensated to control the output power of LED 5. The temperature coefficient and electronic characteristics of LED 5 at manufacturing temperature can be measured and stored in the memory of IC 9. The temperature coefficient of LED 5 can be used to compensate for temperature changes at run time or differences between run time temperature and manufacturing temperature. LED 5 can be used to measure the junction temperature of LED 5 at run time using the temperature coefficient and electronic characteristics of LED 5. Electronics to measure the junction temperature of LED 5 at run time can be integrated in IC 9. The first or second reference voltage for the comparator can be compensated so the integration time of the photocurrent is constant or nearly constant with respect to changes in run temperature or difference between run time temperature and manufacturing temperature.

Reactions 35 can provide higher signal to noise ratio at higher reaction temperatures, namely physiological temperature between 30C and 40C, such as 30C, 35C, 36C, 37C, 38C, 39C or 40C. IC 9 can integrate circuits to raise the reaction temperature of reactions 35 or maintain reaction temperature to within 2C, 1C, 0.5C, 0.25C, 0.125C of a desired reaction temperature. IC 9 can integrate one or more heaters circuits to raise the reaction temperature of reactions 35 or maintain reactions 35 at to within 2C, 1C, 0.5C, 0.25C, 0.125C of a desired reaction temperature. The heaters can be heater resistors. Heater resistors can be integrated in IC 9. Heater resistors can be integrated into the silicon substrate of IC 9. Heater resistors integrated into the silicon substrate of IC 9 can be n-well, p-well or doped well resistors. Heater resistors can be integrated into the inter-layer dielectric (ILD) of IC 9. Heater resistors integrated into the ILD can include resistors fabricated out of poly-silicon or metal. The heater can be heated to a run time heater temperature. The run time heater temperature can be measured by a temperature sensor. The reaction temperature can be measured by a temperature sensor.

A temperature sensor can be placed in proximity to the heater. A temperature sensor can be placed to within 1 mm, 500 um, 250 um, 125 um, 100 um, 50 um, 25 um, 20 um, 10 um or 5 um of the heater for superior temperature control. The heater can be a temperature sensor. A temperature sensor can be placed in the ILD near or at the surface of the IC to measure the reaction temperature or the temperature of the plasma 17 in well 19 above the IC. The reaction temperature can the temperature of the plasma 17 in well 19. Metal pads or vias can be used to thermally couple plasma 17 in well 19 above IC 9 to a sensor embedded in IC 9.

The power through the heater can be modulated. Examples of heater modulation schemes include pulse width modulation, amplitude modulation and frequency modulation. The run time heater temperature can be different than the reaction temperature by a heat loss offset. IC can compensate for the heat loss offset by increasing the run time heater temperature. The heat loss offset can be estimated using the steady state power consumption of the heater. The heater can be a well resistor embedded in the silicon substrate of IC 9. The heater can be circular and circumscribe around the outer perimeter of photodetector 8. The heater can be constructed from a number of separate resistor in parallel and series. The heater can be powered using digital pulse width modulation techniques. The volume of plasma in well 19 can be less than lul and the distance from photodiode 8 to the opposite end of well 19 can be less than 1 mm to ensure rapid and even distribution of the heat from the heater to the plasma 17.

### Photodetector

All the photodetectors on IC 9 can be equidistant from one another and arranged in a line. Deviations from this linear equidistant photodetector placement can be less than 1 mm, 0.5 mm, or 0.25 mm. The photodetectors on IC 9 can be approximately equidistant from one-another and approximately arranged in a line. The photodetectors on IC 9 can less than 3 mm, 2.5 mm, 2 mm, 1.75 mm, 1.5 mm, 1.25 mm, 1 mm, or 0.5 mm apart. Photodetector 8 can be any photoelectric device sensitive to the intensity of light. Photodetector 8 can be an active pixel sensor or charge coupled sensor. Photodetector 8 can be any photosensitive CMOS device. Photodetector 8 can be a photodiode. Photodetector 8 can be a polysilicon photodiode or a photodiode embedded in the substrate. Photodetector 8 can be n-doped or a p-doped well diode. Photodetector 8 can be implemented in an isolation well or in a stacked configuration to eliminate cross-talk from other photodetectors integrated in IC 9 or other noisy electronics integrated on IC 9. The passivation and dielectric layers above photodetector 8 can be thinned or etched to minimize attenuation of light through the ILD before reaching the embedded photodetector 8. Silicon dioxide from the ILD of IC 9 can have similar refractive index as plasma 17. Silicon dioxide from the ILD can be exposed above photodetector 8 to eliminate reflections. Standard passivation layers like polyimide and silicon nitride with different diffractive indexes to plasma 17 be etched, removed or eliminated above photodetector 8. The optical detection frequency be ultra-violet (UV), namely at 340 nm and 405 nm wavelengths. Light 21 at 340 nm and 405 nm wavelengths may not penetrated deep into the silicon substrate. To improve the quantum efficiency of photodetector 8 for 340 nm or 405 nm wavelengths, photodetector 8 can comprise a shallow junction photodiode integrated in the silicon substrate. The depth of the junction of photodetector 8 can be less than 5 um, 4 um, 3 um, 2 um, 1 um, 0.5 um or 0.25 um. The profile of the junction can be exponentially decreasing or a buried Gaussian. An epi-layer, or a buried implant layer or a buried reverse implant layer can be embedded in the silicon substrate below the junction of the photodiode 8 to tailor the junction thickness and increase sensitivity at UV optical frequencies.

Photodetector 8 can be larger on a side than 10 um, 50 um, 100 um, 200 um, 300 um, 400 um, 500 um, or 1 mm. The area of photodetector can be larger than 100 um², 1000 um², or 1 mm². The area of photodetector 8 can be larger than or equal to the cross sectional area of the aperture of well 19 in proximity to photodetector 8 to capture all the light 21 that enters well 19.

Multiple photodetector can be placed below each well 19. The photodetectors can be manufactured using different materials or have one or more optical color filters patterned or placed on them to discriminate different frequencies of light 21. The surface of the IC 9 can be coated with an anti-reflective coating (ARC) to minimize the amount of light that reflects off the surface of the IC 9 before reaching photodetector 8.

Photodetector 8 can be placed below, above or laterally to well 19 such that photodetector 8 can detect or measure the intensity of the light that traveled through well 19 along path length 39. Photodetector 8 can detect or measure the plasma absorption of plasma 17 in well 19 along path length 39. The Photodetector 8 can be integrated into IC 9. IC 9 can be embedded inside, above, on or below PCB 3. IC 9 can be mounted parallel to or flush with PCB 3.

### Plasma Filter

Filter 2 can comprise one or more plasma separation membranes, one or more structures to elute filter reagents 32, one or more structures to promote mixing of plasma 17 with filter reagents 32 or one or more structures to slow or control the flow of plasma 17. Filter 2 can comprise multiple stacked, abutted, offset or laminated filters. Filter 2 can be square, circular or any other arbitrary shape. Filter 2 can be manufactured from polyethersulfone/polyvinylpyrrolidone (PES/PVP) and have graduated porosity to trap red blood cells. Filter 2 can be coated with glycine or other reagents to minimize cell leakage and lysis. The area of filter 2 can be less than 10 mm² or 30 mm² or 100 mm² or 300 mm² and can accept less than 50 ul, 25 ul, 15 uL, 10 ul, 5 ul of whole blood. Filter 2 can be mounted in proximity, above, below, on or laterally to surface 11 or AOW 4. Filter 2 can accept whole blood 16 and block red blood cells from flowing to well 19. Platelets and white blood cells are interferers in spectrophotometer implementations due to light scattering. Historically, the solution to eliminating white blood cells has been to spin down the whole blood for an extended period of time and remove the buffy layer. Filter 2 can be configured to rapidly block white blood cells and platelets. Filter 2 can have a constriction layer with pore size smaller than 2.5 um, 2 um, 1.5 um, 1 um, 0.75 um, or 0.5 um.

Filter 2 can be mounted above, below, laterally or in proximity to surface 11 or AOW 4. The distance from filter 2 to surface 11 can be less than 0.5 mm, 200 um, 100 um, 50 um, 25 um, 10 um, 1 um. Filter 2 can be snap-fit, friction fit, heat staked, glued or adhered to surface 11 or AOW 4. Filter 2 can be adhered to surface 11 or AOW with double-sided tape 10. Filter 2 can contact surface 11 or AOW 4. Plasma can flow through filter 2 onto surface 11. Filter 2 can be impregnated with dried filter reagents 32 that become dissolved into plasma 17.

### Plasma Flow

Filter 2 can be in proximity to and fluidically connected to spectrophotometer 15 such that plasma 17 from whole blood 16 can flow directly or indirectly from filter 2 into spectrophotometer 15. Plasma 17 from whole blood 16 can flow passively from filter 2 into spectrophotometer 15 without assistance from the user or pneumatic forces. Plasma 17 from whole blood 16 can flow from filter 2 into spectrophotometer 15 as a result of surface tension effects, such as capillary or low contact angle on surface 11. Filter 2 can be in proximity to or fluidically connected to well 19 such that plasma 17 from whole blood 16 can flow directly or indirectly from filter 2 into well 19. Plasma 17 from whole blood 16 can flow passively from filter 2 into well 19 without assistance from the user or pneumatic pressure differentials. Plasma 17 from whole blood 16 can flow from filter 2 into well 19 as a result of surface tension effects, such as capillary effects in well 19 and low contact angle on surface 11. Filter 2 can be fluidically connected to spectrophotometer 15 by surface 11. Filter 2 can be fluidically connected to well 19 of spectrophotometer 15 by capillary 22. Surface 11 can be the surface of a printed circuit board (PCB) 3 or the surface of the Array of Wells (AOW) 4 or the 8 surface of an integrated circuit (IC) 9. Surface 11 can be co-planar with IC 9, wherein surface 9 can be the surface of photodetector 8. Light 21 can transmit in a single direction through surface 11 before illuminating photodetector 8. The path of light 21 can include surface 11. Surface 11 can be in the path of light 21 traveling from LED 5 to detector 8. The surface of photodetector 8 can be incorporated in surface 11. The surface of IC 9 can be incorporated in surface 11 using a method described in Murali, P. Izyumin, I. Prabhu, S. Cohen, D. Boser, B. (2014). A MAGNETIC FLOW CYTOMETER WITH INTEGRATED MICROFLUIDICS. 159-162. 10.31438/trf.hh2014.44. The surface of the IC can be the surface of photodector 8.

Surface 11 can be hydrophilic or coated with a hydrophilic reagent 31. Plasma 17 from whole blood 16 can flow on surface 11 into well 19 or into capillary 22. Plasma 17 can flow between surface 11 and filter 2 into well 19 or capillary 22. Plasma 17 can flow through filter and through the edge 20 of filter 2 into capillary 22 and well 19. Plasma 17 on surface 11 can flow into capillary 22 of spectrophotometer 15 due to the low contact angle of plasma 17 on surface 11. Plasma on surface 11 can flow through capillary 22 and into well 19. Capillary 22 can be formed by the proximity of AOW 4 or IC 9 and surface 11. Capillary 22 can be formed between AOW 4 or IC 9 and surface 11. Plasma in surface capillary 22 can flow into well 19 by capillary action. Well 19 and capillary 22 can be fluidically connected such that plasma in capillary 22 can flow into well 19. Plasma 17 can fill well 19. Filter 2 can be fluidically connected to well 19 through surface 11 and surface capillary 22. Capillary 22 can be parallel to surface 11.

The edge 20 of filter 2 can be in proximity or in contact with AOW 4 or IC 9. Filter 2 can have a barrier 13 that can prevent red blood cells in whole blood 16 from passing through edge 20 onto surface 11 and capillary 22. Filter 2 can have a barrier 13 that can allow plasma 17 in whole blood 16 to pass through edge 20 onto surface 11 and capillary 22. The edge 20 of filter 2 can be in proximity or in contact with photodetector 15. The edge 20 of filter 2 can be in proximity or in contact with capillary 22. Filter 2 or edge 20 of filter 2 can be partially or completely inside capillary 22. Filter 2 can contain a barrier 13 and wherein barrier 13 can be inside capillary 22.

Barrier 13 can be a notch, depression, indent, hydrophobic barrier or any feature in filter 2 that can reduce or eliminate the passage of whole blood cells through or around edge 20 or around filter 2 into plasma 17. Barrier 13 can be a notch, depression, indent, hydrophobic barrier or any feature along edge 20 of filter 2. Barrier 13 can be manufactured by crushing filter 2 wherein blood cells are blocked from traveling through, over or under the crush region. The crush region can be less than 5 mm, 2 mm, 1 mm, or 0.5 mm or 0.25 mm from the edge of filter 2. Barrier 13 can be manufactured by crushing filter 2 along edge 20. The presence of whole blood cells in well 19 can interfere with the chemistry measurements. Barrier 13 can be a material blocking the movement of whole blood cells on, along or through edge 20 or filter 2. Barrier 13 can a physical dam or barrier on edge 20. Barrier 13 can slow, reduce or prevent whole blood cells from mixing with plasma 17 in gap 12, under filter 2 or in capillary 22. Barrier 13 can be on top of filter 2 and can prevent whole blood cells from 17 passing through edge 20 or over the top of filter 2. Barrier 13 can be on filter 2 in proximity to edge 20.

Gap 12 can be the space between AOW 4 or IC 9 and filter 2. Gap 12 can be the space between AOW 4 or IC 9 and edge 20 of filter 2. Barrier 13 can reduce or eliminate blood cells from wicking through or over edge 20 into gap 12 or surface 11 or capillary 22 and ultimately into well 19. The length of gap 12 can be less than 5 mm, 2 mm, 1 mm, 0.5 mm, 0.2 mm, 0.1 mm, 0.05 mm, or 0.025 mm. The length of gap 12 can be defined as the distance between filter 2 and AOW4 or IC9. The gap 12 or barrier 13 can be used to control the or slow down the flow of plasma into well 19 and promote mixing. Surface 11 adjacent to gap 12 can be hydrophilic such that plasma under filter 2 can sheet or flow across surface 11 adjacent to gap and into capillary 22 or well 19. There may be no material such as a filter or AOW or IC directly atop surface 11 over gap 12.

The length of gap 12 can determine time necessary for plasma under filter 2 to sheet or flow across surface 11 adjacent to gap 12. Surface 11 adjacent to gap 12 can be exposed. The length of gap 12 can be long enough to ensure proper mixing of dissolved reagents in plasma 17.

### Light Emitting Diode

LED 5 can be mounted on surface 11, PCB 3 or PCB 62 using epoxy, tape, an electrical socket, wirebonds, bump bond or reflowed or soldered electrical connections. LED 5 can emit light 21 with narrow band optical spectrum centered on a peak frequency, namely the optical detection frequency 60. LED 5 can emit light 21 with a narrow band optical spectrum with a FWHM of less than 200 nm, 100 nm, 50 nm, 25 nm, 20 nm, 15 nm, 10 nm, 5 nm, 4 nm, 3 nm, 2 nm or 1 nm. Spectrophotometer 15 can be a single frequency spectrophotometer, wherein spectrophotometer 15 can produce or measure the intensity of light 21 at only one optical frequency, namely the optical detection frequency 60. Disposable 1 can contain a plurality of single frequency spectrophotometers. Each of the plurality of single frequency spectrophotometer can produce or measure the intensity of light at a different optical detection frequency. The plurality of single frequency spectrophotometers can contain plasma from the filter 2 of different filters. The plurality of single frequency spectrophotometers can be fluidically connected to filter 2 or different filters. The plurality of single frequency spectrophotometers can be fluidically connects the surface 11 or different surfaces. Disposable 1 can have multiple LEDs emitting at different optical detection frequencies. A plurality of LEDs can be mounted on the same surface 11, PCB 3 or PCB 62. A plurality of LEDs can be mounted on different flex PCBs.

LED 5 can emit light 21 with a wide angle emission profile. LED 5 can be packaged with a lens 57 to direct or concentrate light 21 towards for example an input lens 58 of reflector 6.

LED 5 can be packaged using plastic or quartz or be a package-free bare die. LED 5 can be flipped chip bonded onto a PCB and the illumination can emit from the backside of LED 5, opposite the bonding pads. LED 5 can be chip-on-board mounted on a PCB. Plastic packages can degrade in UV light, but since disposable 1 is a single-use disposable, long term degradation of the LED package is not a concern. LED 5 can be a laser diode emitting a laser or coherent light.

LED 5 can be constructed of Aluminum Gallium Nitride (AlGaN) or Gallium Nitride (GaN) or both. LED can be constructed from typical LED materials known in the art. The substrate for LED 5 can be sapphire or silicon carbide or other more typical LED substrates known in the art. LED 5 constructed from AlGaN or GaN can emit with peak frequencies at 340 nm and 405 nm. LED 5 constructed from AlGaN or GaN can be low power and can be powered by a single battery.

The LED 5 can be flip chip bonded onto a PCB 3. PCB 3 can feature registration and the flip-chip bonding process can result in LED 5 positional errors. To overcome these errors, LED 5 can be placed on PCB 3 first and IC 9, AOW 4 and reflector 6 can be placed on PCB subsequently to LED 5 and registered to LED 5. In some cases, components will be mounted on the other side of the PCB. LED 5 can be registered to a through-feature like one or more vias or one or more edges of PCB 3, and IC9, AOW 4 and reflector 6 can be registered to the same through-features.

Spectrophotometer 15 can be encased in an optical shield 82 that blocks light from the exterior from entering well 19. Optical shield 82 can be on disposable 1 in housing 44.

A plurality of LEDs can operate at a plurality of optical frequencies and can be packaged together in a LED cluster 130. The LEDs in LED cluster 130 can be mounted directly on PCB 3 by wire-bonding, soldering, chip-on-board, flip-chip, epoxy or other assembly techniques. The LEDS in LED cluster 130 can be packaged into a LED package, which can be mounted on PCB 3 by wire-bonding, soldering, chip-on-board, flip-chip or other assembly techniques. Each LED in LED cluster 130 can be turned on and can illuminate individually or simultaneously. The LEDs in LED cluster 130 can illuminate input lens 58 such that the light from the LEDs in LED cluster 130 can be redirected through well 19 and onto photodetector 8. LED cluster 130 can emit light at a plurality of discrete optical frequencies.

The actual path lengths of the plurality of lights from the plurality of LEDs in LED cluster 130 can be within 20%, 15%, 10%, 5%, 3%, 2%, 1% of a nominal path length. A plurality of wells can be illuminated by all the LEDs in LED cluster 130. This enables offset cancellation of background measurements of opacity and dynamic cancellation of measurement drift. The LEDs in LED cluster 130 can be smaller than 10 mm², 4 mm², 2 mm², 1 mm², 0.5 mm², 0.25 mm² or 0.1 mm² in cross sectional area. The LED cluster 130 can contain 2, 3, 4, 5, 6, 7, 8 or more LEDs. The LED package can be ceramic or plastic.

A plurality of reactions can be performed in well 19. The plurality of reactions in well 19 can be monitored at different optical frequencies. A plurality of optical frequencies can be emitted by the LEDs in LED cluster 130 to monitor a plurality of reactions in well 19. Signal cross talk between a plurality of reactions in well 19 can be de-convolved. The light intensities of the LEDs in LED cluster 130 can be modulated to measure the gain of each LED as measured by photodetector 8. Deconvolution factors can be stored in the non-volatile memory chip 153 on PCB 3 or non-volatile memory integrated in IC 9. Assay calibration information can be stored on the non-volatile memory chip 153 on PCB 3 or non-volatile memory integrated in IC 9.

### Array of Wells

The AOW 4 can comprise an array of 1 to 100 wells, in which the transmittance of plasma 17 with reporter molecule 56 can be measured. One or more AOW 4 can be mounted in proximity, above, below, on or laterally to surface 11, PCB 3 or IC 9. AOW 4 can be positioned in proximity, below, above, on, laterally to, adjacent to or in contact to filter 2 or edge 20 of filter 2, or barrier 13 of filter 2. AOW 4 can contain well 19. AOW 4 can be opaque to the optical detection frequency 60 to avoid signal cross talk among the wells. A single AOW 4 can be shared among multiple spectrophotometers. Reflector 6 can be over-molded onto AOW 4. AOW 4 can be constructed from standard injection molded plastics. AOW 4 can contain a pocket for the wirebonds of IC 9. AOW 4 can contain a pocket that crushes filter 2 and creates barrier 13. Capillary 22 can be formed in between AOW4 or IC 9 and surface 11. AOW 4 can contain capillary 22.

Well 19 can be a capillary with parallel surfaces. The parallel surface of well 19 in the configuration of a capillary can be perpendicular to light 21, wherein light 21 enters through one parallel surface and exits through the parallel surface on the opposite side of the capillary. Light 21 can pass through capillary 22, wherein AOW 4 is constructed with material transparent to light 21.

Well 19 can have a maximum depth of 5 mm, 3 mm, 2 mm, or 1.5 mm, or 1 mm, or 0.75 mm, or 0.6 mm, or 0.5 mm, or 0.4 mm. Well 19 can have a maximum diameter of 2 mm, 1.5 mm, 1 mm, 0.75 mm, 0.5 mm, 0.4 mm, 0.3 mm or 0.25 mm. Well 19 can be cylindrical with drafted sidewalls.

The AOW 4 can be snap-fit, friction fit, heat staked, glued or adhered to surface 11. AOW 4 can be adhered to surface 11 with double-sided tape 10. AOW 4 can be machined or injection molded. AOW 4 can be manufactured from an injection moldable plastic such as Polymethylmethacrylate (PMMA), Acrylonitrile butadiene styrene (ABS) or hydrophilic polymers. AOW 4 can be transparent, translucid or opaque. AOW 4 can have mounting points or through holes for reflector 6. Surface 11 can have mounting points or through holes for AOW 4 and reflector 6. AOW 4 can have capillary draw texture on the inside of the wells.

The inner volume of well 19 can be less than 2 uL, or 1 uL, 0.5 uL, or 0.25 uL, or 0.1 uL of plasma 17. Well 19 can be vertical or positioned at an angle vis-a-vis surface 11. Well 19 can have tapered sidewall to promote capillary action.

### Tape Design

Double sided tape 10 can be mounted on surface 11. The AOW 4 can be mounted above, below, on or laterally to tape 10. Filter 2 and filter 55 can be mounted above or below, on or laterally to tape 10. Filter 2 and AOW 4 can abut or be separated by a gap 12, wherein the surface 11 adjacent or nearest to gap 12 can be exposed or uncovered.

Tape 10 can contain between 1 and 100 slots or channels that can fluidically connect one or more filters with one or more wells in one or more AOWs, such that plasma 17 from the one or more filters can flow unassisted into one or more wells. Channel 25 in tape 10 can direct the plasma 17 from filter 2, across gap 12, into capillary 22 and into well 19. Capillary can be formed by surface 11, AOW4 and channel 24. Capillary 22 can be formed by surface 11, IC 9 and channel 25. Channel 25 can fluidically connect filter 2 to well 19. Slot 25 in tape 10 can direct the plasma 17 from filter 2 into well 19.

Channels 23 and 25 can be fluidically isolated from one another on surface 11 such that plasma in one channel cannot flow into another channel or plasma in one channel cannot mix with plasma from another channel. Plasma in channels 23 and 25 can have different dissolved reagents. Channel 23 can delineate a separate reaction chamber, where a distinct chemical reaction 35 can be performed. A channel can contact a plurality of wells to a single filter.

Double-sided tape 10 can be hydrophobic or hydrophilic. Tape 10 can be hydrophobic to avoid delamination after prolonged exposure to plasma 17. Also, the use of hydrophobic tape 10 can facilitate spotting of different surface reagents spotted in different slots by eliminating unwanted mixing. Tape 10 can be thin to minimize the dead volume of plasma 17 and therefore to reduce the amount of whole blood 16 needed to run disposable 1. The thickness of Tape 10 can be less than 1 mm, 0.1 mm, 0.05 mm, 0.025 mm or 0.01 mm. Multiple slots can connect to multiple fluidically isolated filters but channel multiple plasmas to the same AOW or to same well in AOW. Multiple slots can connect to a single filter 2.

### Reflector

Reflector 6 can be composed of multiple optical elements. Optical elements can be optical splitters, optical combiners, mirrors, lenses, optical diffusers, passive optical amplifiers, apertures, fully or partially reflective surfaces, total internal reflective surfaces, waveguides and other features to control or direct light 21. The reflector 6 can be injection molded from an injection moldable plastic transparent to light 21. However, for directing shorter wavelength lights like 340 nm and 405 nm light, the material from which the light-pipe or waveguide is manufactured can be transparent or translucent to ultra-violet light, such as cyclic olefin copolymers or PMMA. The refractive index of reflector 6 can be higher, lower or within 10%, 20%, 30%, 50%, 100% of the refractive index of plasma 17.

A first optical element 28 can redirect light 21 approximately 90° from LED 5 to a second optical element 29. The second optical element 29 can redirect light 21 approximately 90° from the first optical element 28 into plasma 17 in well 19. The first or second optical elements can also split light 21, focus light 21 or change the radiation pattern of light 21. Reflector 6 can direct light 21 from one diode to a plurality of wells. Reflector 6 can direct the light from a plurality of diodes into a well 19.

Reflector 6 can have a protrusion 50. Protrusion 50 can act as a waveguide. Protrusion can contact plasma 17 in well 19. Protrusion 50 can penetrate well 19 or be mounted in well 19, on the opposite side of photodetector 8. Protrusion 50 can contain a lens 51 that focuses the light from LEDs 5 or 26 onto the bottom of well 19. Protrusion 50 in reflector 6 can channel or direct the light from second optical element 29, through lens 51 and into the plasma 17 in well 19. Lens 51 can also be flat or concave. Lens 51 can be convex to avoid bubbles being trapped underneath it when well 19 fills by capillary action from the bottom up. The center of lens 51 can be the first point on reflector 6 that touches plasma 17 as well 19 fills. Photodetector 8 can be exposed to light 21 from LED 5 that traverses from protrusion 50 or lens 51 directly into plasma 17 in well 19. Light 21 can exit protrusion 50 through lens 51. Lens 51 can form the tip of protrusion 50. Lens 51 can focus light 21 onto photodetector 8. Protrusion 50 and lens 51 can be mounted above well 19 or inside well 19. Protrusion 50 and lens 51 can be centered with respect to well 19. Protrusion 50 or lens 51 can contact plasma 17 at one end of well 19, opposite photodetector 8. Protrusion 50 or lens 51 can contact the sidewalls of well 19 opposite photodetector 8. A vent 52 can be formed between the protrusion or lens 51 and the sidewall of well 19. Vent 52 can allow air inside well 19 to exit out of well 19 to maintain capillary action in well 19. Protrusion 50 and lens 51 can be in proximity to well 19 without contacting well 19. The minimal distance between protrusion 50 or lens 51 and the sidewall of well 19 can be less than 1 mm, 0.5 mm, 0.25 mm, 0.1 mm, 0.05 mm, 0.025 mm, 0.01 mm, 0.005 mm, or 0.001 mm. The vent 52 can be an annulus around the top rim of well 19.

Lens 51 or protrusion 50 can be above plasma 17or well 19 and avoid contacting them. Lens 51 can focus light onto the aperture of well 19 opposite photodetector 8. The aperture of well 19 opposite the photodetector 8 can be reduced to minimize the optical interference of the meniscus of the plasma 17 on the illumination of photodetector 8. The diameter of the top aperture of well 19 can be less than 2 mm, 1.5 mm, 1 mm, 0.75 mm, 0.5 mm, 0.4 mm, 0.3 mm, 0.2 mm, or 0.1 mm. The sidewalls of well 19 can be drafter to improve capillary flow, eliminate light reflecting off the sidewalls and to reduce the diameter of the top aperture of well 19. The diameter of the aperture of well 19 opposite photodetector 8 can be smaller than the diameter of the aperture of well 19 closest to photodetector 8.

Protrusion 50 and lens 51 can be used for underfill and overfill control. The assay measurement can begin when plasma 17 contacts lens 51 or protrusion 50. The amount of light that reaches photodetector 8 can increase, decrease or change abruptly when plasma 17 contacts lens 51 or protrusion 50. The change in the amount of light on photodetector 8 when plasma 17 contacts lens 51 or protrusion 50 can be detected and used to begin the assay measurement in well 19. The assay measurements in different wells can begin at different times. The change or lack of chance in the amount of light that reaches photodetector 8 when plasma 17 contacts lens 51 or protrusion 50 can be used to indicate under-fill situations where not enough sample was applied to filter 2.

Reflector 6 can have a third optical element 53 to collect, focus or split light directly from LED 5, wherein LED 5 can be unpackaged and emit light across a wide angular pattern.

Lens 51 can have an emitter surface 201 that can contact plasma 17 in well 19. Protrusion 50 can have an emitter surface 201 that can contact plasma 17 in well 19. Light 21 can transmit through emitter surface 201 before entering well 19. Light 21 can transmit through emitter surface 201 and travers plasma 17 in well 19. Emitter surface 201 can be smooth to increase the transmission of light 21. Emitter surface 201 can be rough or textured to decrease the transmission of light 21. The refractive index of the protrusion 50 or lens 51 can be similar to the refractive index plasma, or within 5%, 10%, 20%, 50% or 100% of the refractive index of plasma. Lens 51 or protrusion 50 can be flat, concave or convex. Lens 51, protrusion 50 or the surface 201 of protrusion 50 can be configured to hold a drop of over 1 nL, nL, 3 nL, 4 nL, 5 nL, 6 nL, 7 nL, 8 nL, 9 nL 10 nL, 20 nL, 50 nL of wet critical reagents in a wet dispense state on emitter surface 201. Critical reagents can by dried on emitter surface 201, or lens 51 or protrusion 50. Dry critical reagents can absorb more than 1%, 2%, 5%, 10%, 20%, 30% 50%, 80%, 90% or 99% of the light at optical frequency 60 passing through emitter surface 201. The dissolution of the dry critical reagents into the plasma 17 in well 19 can result in a large spike in the transmission of light from the LED to the photodetectors. A large spike in the transmission of light from the LED to the photodetectors can be a signal to indicate well 19 is full of plasma 17. Disposable 1 can be configured to detect the change in opacity from the dissolution of the dry critical reagents.

### Housing

Disposable 1 can also include a desiccant 43, a display 41 and one or more batteries 40 to provide power to LED 5, IC 9 and display 41. Display 41 and battery 40 can be electrically connected to IC 9. Display 41 and battery 40 can be electrically connected to PCB 3. The disposable 1 can include a plastic housing 44 to encase disposable 1 and all the sub-components. The housing 44 can have branding and test identifiers and a QR code printed or molded on its exterior. Disposable 1 can have a button 45 or a pull tab 61 to activate disposable 1. Display 41 of disposable 1 can prompt a user to apply a drop of whole blood 16 on filter 2. Display 41 can display the results of a chemistry test. Display 41 can display to the use such are over-sampling or under-sampling situations, the time remaining until the assay is complete, error codes or other information.

Disposable 1 can be configured to accept less than 50 uL of whole blood, or less than 15 uL of whole blood, or less than 10 uL of whole blood or less than 5 uL of whole blood. The results from the measurement from disposable 1 can be displayed on display 41 or wirelessly transmitted to a nearby wireless device. Disposable 1 can have a near-field communication (NFC) wireless module. In cases where the change in the=optical density of the light transmitted through the plasma 17 changes quickly, disposable 1 can report results as soon as they are available. Results can be reported in less than 15 minutes, or less than 10 minutes, or less than 5 minutes, or less than 3 minutes, or less than 1 minute. Digital display 41 can be a liquid crystal display (LCD), a dot matrix display, an organic LED (OLED) display, an e-ink display or other displays. Display 40 can display the concentration of one or more analytes 36. Battery 40 can power spectrophotometer 15 and display 41. Spectrophotometer 15 can comprise an integrated circuit (IC) 9. Disposable 1 can have a single PCB 3. PCB 3 can be a 2 layer PCB.

Disposable 1 can be integrated into a blood collection system that is fitted onto a patient and take whole blood from the patient. Disposable 1 can be integrated into the blood collection system and can take whole blood from the blood collections system for analysis. The blood collection may or may not have an LCD to display the assay results. The assay results can be transmitted wirelessly to a nearby mobile device. Battery 40 can be a coin cell battery. Battery 40 can be a single coin cell battery.

Top housing 91 can contain a drop pin 143. Drop pin 143 can be a protrusion or extension from the bottom surface of top housing 91. Drop pin 143 can be manufactured from the same material and at the same time as top housing 91. Drop pin 143 can contact or press filter 2. Drop pin 143 can press filter 2 into surface 11 such that filter contacts surface 11. Drop pin 143 can press on the corner of filter 2, away from the center of filter 2. Drop pin 143 can be configured to keep filter 2 from lifting off surface 11 after prolonged exposure to plasma 17 or other fluid. A plurality of drop pins can press a single filter 2. Drop pin 143 can be configured to ensure that the filtered plasma 17 wicks or flows into surface 11. Drop pin 143 can fluidically connect filter 2 with surface 11. Drop pin 143 can have a fluid-stop feature like ribs, steps, hydrophobic coating or other features configured to stop or resist fluid from wicking up the drop pin. Drop pin 143 can completely crush or partially crush filter 2.

Top Housing 91 can have an inlet cuvette 140. Disposable 1 can have a single inlet cuvette 140 that can be fluidically connected to multiple filters or sensors. Inlet cuvette 140 can accept or hold one ore more drops of whole blood 16, plasma 17 or other sample or fluid. Inlet cuvette 140 can be conical or bowl-shaped or any shape that converges or opens onto inlet 66. Inlet cuvette 140 can be positioned above, below or lateral to inlet 66. Inlet cuvette 140 can be fluidically connected to inlet 66. A hydrophobic portion 142 of the inlet cuvette 140 can be a portion of inlet cuvette 140 that can be manufactured from a hydrophobic material or coated with a hydrophobic layer. Inlet cuvette 140 can be manufactured of hydrophobic material, in which case all of inlet cuvette 140 can be the hydrophobic portion 142. The hydrophobic portion 142 can be the top half of the inlet cuvette 140. The bottom of the inlet cuvette 140 can be manufactured from a hydrophilic material or coated with a hydrophilic layer to promote flow of plasma 17, whole blood 16 or other fluid into inlet 66. The walls of inlet cuvette 140 can be more than 45° degrees from the normal to surface 11. The walls of inlet cuvette 140 can be less than 45° degrees from the normal to surface 11. Inlet cuvette 140 can be a narrow cone to reduce the volume of plasma 17 or fluid that can be introduced. The inlet cuvette 140 can be open or a flat surface.

Top Housing 91 can be manufactured from a hydrophobic material like a hydrophobic plastic or a super-hydrophobic material. The component of whole blood can be cells, lipids, plasma, proteins and any other organic constituent of whole blood. The constituents of plasma can be water, proteins, lipids, nucleic acids, electrolytes, metabolites and other water soluble molecules. The bottom of inlet cuvette 140 and inlet 66 can be hydrophilic and promote passive flow of whole blood 16, plasma 17 or fluid by capillary action.

Disposable 1 can contain a hydrophobic pump that can consist of an inlet cuvette 140 with a hydrophobic portion 142, fluidically connected to an inlet 66. Inlet 66 can be made from a hydrophilic material or coated with a hydrophilic material. The hydrophobic pump can passively push, pressure or repel plasma 17 and whole blood 16 or any fluid out of inlet cuvette 140 and into inlet 66. The hydrophobic pump can create a hydrophobic force that pushes whole blood 16, plasma 17 or fluid contained in the inlet cuvette 140 into inlet 66. The hydrophobic pump can be passive, without any active pumps or valves. The hydrophobic portion 142 can be the portion of inlet cuvette 140 manufactured from or coated with wax, plastic, Teflon, a per- and polyfluoroalkyl substance or any material with high wetting angle or high fluid contact angle like a hydrophobic or super-hydrophobic coating or material. The hydrophobic portion 142 can be constructed of a material or coating that can repel most or all the components of whole blood. The components of whole blood can include the cellular component like red blood cells and white blood cells and the plasma component that includes the fluid portion of whole and dissolved sub-components. The hydrophobic portion 142 can be constructed from or coated with any material that has a high contact angle or high wetting angle will most or all constituents of whole blood 16. The hydrophobic portion 142 can maximize or increase the surface energy of the whole blood 16 or plasma 17 in inlet cuvette 140, therefore pushing, pressing or repelling it into inlet 66 through minimization of surface energy. The hydrophobic portion 142 can be configured to push or pressure the whole blood 16 or plasma 17 out of inlet cuvette 140 and into the hydrophilic portions of disposable 1. The hydrophobic portions 142 can be fluidically connected to the hydrophilic portions of disposable 1. The hydrophobic portion 142 can push or pressure plasma 17 through filter 2. The hydrophobic portion 142 can push or pressure plasma 17 into well 19. The hydrophobic portion 142 can push or pressure plasma 17 to fill well 19. The top surface area of filter 2 can be less than 16 millimeters squared, or less than 10 millimeters squared, or less than 5 millimeters squared.

The dispenser of plasma 17 or whole blood 16 into inlet cuvette 140 can be a sample pipette 220, a capillary, a finger, a spoon or a cup. Inlet cuvette 140 can have inlet stand-off 141. Inlet stand-off 141 can be a protrusion, extension or other feature in or on the inlet cuvette configured to prohibit the formation of a hermetic seal with the dispenser, during the dispense of plasma 17 or other fluid into inlet cuvette 140. The formation of a hermetic seal can result in plasma 17 or other fluid being flushed uncontrollably through disposable 1. The prohibition of the formation of a seal by stand-off 141 can guarantee the proper dispense of plasma 17 or other fluid into inlet cuvette 140, and proper function of the hydrophobic pump that can push plasma 17 or other fluid according to intended specifications. The design of the inlet cuvette 140 and stand-off 141 can increase the distance from the dispenser to the inlet 66 or block the dispenser from entering into sample inlet 140 altogether to avoid introduction of bubbles in the plasma 17, whole blood or other fluid introduced in sample inlet 140. When evacuating plasma 17 or the fluid from the dispenser, bubbles can be introduced in plasma 17 or fluid in sample inlet 140. Stand-off 141 can be hydrophilic or hydrophobic.

Inlet 66 can be fluidically connected to inlet capillary 144. Inlet 66 can be fluidically connected to one or a plurality of inlet capillaries 144. Inlet capillary 144 can be constructed by the proximity of a surface of top housing 91 with surface 11. Inlet capillary 144 can be constructed as a channel in tape 10. One or a plurality of inner surfaces of inlet capillary 144 can be coated with a hydrophilic material to promote the flow of plasma 17 or another fluid. Inlet capillary 144 can be configured to fluidically connect inlet 66 to filter 2, a sample electrode 90, an electrochemical sensor, a hematology capillary 147, a well 19, a magnetic sensing IC 83 or a hematology pad 153. Plasma 17, whole blood or another fluid in inlet cuvette 140 can flow through inlet 66, and through inlet capillary 144 to filter 2, a sample electrode 90, an electrochemical sensor, a hematology capillary 147, a magnetic sensing IC 83 or a hematology pad 153.

### Hematology

A hematology system can consist of a bottom slide 148, a top slide 146, a hematology capillary 147, a hematology pad 153, an imaging system 150 and a light source 151. Bottom slide 148 and a top slide 146 can be parallel and can be separated by less than 1 um, 10 um, 100 um, 200 um, 500 um or 1 mm. Bottom slide 148 and top slide 146 can be made of glass, quartz, plastic or other material. Bottom slide 148 and top slide 146 can be transparent to light from light source 151. Bottom slide 148 and top slide 146 can be transparent for imaging system 150. Bottom slide 148 and top slide 146 can be substantially flat or substantially free of aberrations. One or a plurality of hematology capillaries 147 can be formed in between the 17 bottom slide 148 and the top slide 146. The distance between the bottom slide 148 and the top slide 146 and the height of hematology capillary 147 can be configured to permit cells from whole blood to flow between bottom slide 148 and top slide 146 and form one or a plurality of monolayers. Whole blood can contain plasma 17, red cells, white cells and platelets. The surfaces of bottom slide 148 and top slide 146 can be hydrophilic or coated with a hydrophilic material. Hematology capillary 147 and the surfaces of bottom slide 148 and top slide 146 can be configured to wick or draw by capillary action whole blood and plasma. The surface of bottom slide 148 or top slide 146 can be planar with surface 11. Bottom slide 148 or top slide 146 can be mounted inside, on top or next to PCB 3. PCB 3 can have a window or notch or cutout that can opens on bottom slide 148 or top slide 146. Bottom slide 148 or top slide 146 can be connected, mounted or adhered to PCB 3 using leveling compound 145. PCB 3 can have a window or notch or cutout through which light source 150 can illuminate and imaging system 150 can detect or count the number of cells in hematology capillary 147. A wicking pad can be fluidically connected to one end of hematology capillary 147 to ensure continued flow of cells through hematology capillary 147. Whole blood can flow from hematology capillary into wicking pad. The Wicking pad can be at the opposite end of capillary 147 from inlet capillary 144 or hematology pad 153.

Leveling compound 145 can be epoxy, plastic or any other material that can fluidically connect surface 11 with bottom slide 148 or top slide 146. Leveling compound 145 can be hydrophilic or can be coated with a hydrophilic material. Whole blood on surface 11 can flow onto the bottom slide 148 or top slide 146 and into hematology capillary 147. Whole blood in inlet capillary 144 can flow onto the bottom slide 148 or top slide 146 and into hematology capillary 147. Bottom slide 148 or top slide 146 can be separate or disconnected from PCB 3. Bottom slide 148 or top slide 146 can be fastened, adhered, taped, held or mounted into top housing 91, or another component connected to top housing 91. Bottom slide 148 or top slide 146 can be independent from disposable 1 and placed separately into reader 100. Bottom slide 148 or top slide 146 can be independent from disposable 1 and placed into a separate port in reader 100.

Hematology pad 153 can contain dry hematology reagents like stains and coagulation factors, particles, magnetic particles, Wright stain, antibodies that can bind to cells, DOACs or DOAC antidotes. Hematology pad 153 can release dissolved hematology reagents into the whole blood in hematology capillary 147. Whole blood in hematology capillary 147 can have dissolved hematology reagents. The hematology reagents can react or bind with whole blood cells or plasma 17. Hematology reagents can lyse whole blood cells. Hematology pad 153 can have pore sizes larger than the diameter of whole blood cells. Hematology pad 153 can be manufactured from Porex or loose glass fibers. Hematology pad 153 can be configured to allow whole blood cells to pass and can release hematology reagents to perform hematology measurements. Hematology pad 153 can be placed in, on or next to surface 11, housing 91, inlet capillary 144, leveling compound 145, bottom slide 148 or top slide 146. Hematology pad 153 can fluidically connect surface 11, inlet 66 or inlet capillary 144 to hematology capillary 147. Whole blood can flow directly from surface 11, inlet 66 or inlet capillary 144 to hematology capillary 147.

A plurality of hematology capillaries 147 can be integrated in between bottom slide 148 and top slide 146. A plurality of hematology pads 153 can be loaded with a plurality of hematology reagents and can fluidically connect to a plurality of hematology capillaries 147. One or a plurality of hematology measurements can be obtained from a hematology capillaries 147.

Prothrobin time (PT) can be obtained from a hematology capillary 147. Hematology capillary 147 can be over 1 cm, 2 cm, 3 cm, 4 cm, 5 cm, 10 cm, or 100 cm in length. Hematology capillary 147 can make a plurality of turns and snake in between bottom slide 148 and top slide 146. Channels in double sided tape can be used to form hematology capillary 147. Bottom slide 148 or top slide 146 can have posts to register the distance between bottom slide 148 and a top slide 146. The thickness of double-sided tape can determine the distance between bottom slide 148 and a top slide 146. The distance between bottom slide 148 and a top slide 146 can be measured by the imaging system and the hematology measurement can be corrected by that distance. The distance between bottom slide 148 and top slide 146 can be measured during manufacturing and the distance=can be stored in the non-volatile memory chip 153 on PCB 3 or non-volatile memory integrated in IC 9. Hematology pad 153 can contain one or a plurality of clotting factors, DOACs and DOAC antidotes. The prothrombin time of the whole blood can be determined by the motion of the fluid in hematology capillary 147 or by the motion of cells or particles. A plurality of hematology measurements can be obtained simultaneously. 17

The detector for the hematology system can be composed of a light source 151 and an imaging system 150. Light source 151 can emit light at one or more optical frequencies. Imaging system 150 can capture still images and videos of whole blood cells and particles in hematology capillary 147. Light source 151 and imaging system 150 can be on the same or opposite sides of the top or bottom slides. Machine learning or Artificial Intelligence software can be configured to process the still images or videos. The hematology system can be configured to determine the number of cells or particles, the type of cells or particles, the movement or Brownian motion of cells or particles and the rates of flow of fluids or cells or particles in hematology capillary 147. Light source 151 and imaging system 150 can be incorporated in disposable 1 or reader 100. The imaging system 150 can have high magnification and resolution to identify organelles of cells.

Light source 151 can be an LED 5 or LED cluster 130. Reflector 6 or a separate reflector can guide light from LED 5 or LED cluster 130 through hematology capillary 147 and onto imaging system 150. The reflector can have a diffuser to provide uniform illumination. Imaging system 150 can be integrated into disposable 1 to eliminate the need for reader 100 altogether or reduce the complexity of reader 100.

Disposable 1 can be inserted into port 101 or into reader 100 before a drop of blood is deposited onto inlet cuvette 140. The entirety or a portion of top slide 146 can be inserted into port 101 or into reader 100 before a drop of blood is deposited onto inlet cuvette 140. The entirety or a portion of bottom slide 148 can be inserted into port 101 or into reader 100 before a drop of blood is deposited onto inlet cuvette 140. The connector on disposable 1 can be mated with the connector in reader 100 before a drop of blood is deposited onto inlet cuvette 140. Inlet cuvette 140 can be accessible or can be outside reader 100 or port 101 when the connector on disposable 1 is mated with the connector in reader 100 or port 101. Inlet cuvette 140 can be accessible or can be outside reader 100 or port 101 when the entirety or a portion of bottom slide 148 or top slide 146 are inserted into port 101 or reader 100. Port 101 or reader 100 can have an opening conformal to disposable 1 to reduce the exterior stray light from entering port 101 or reader 100, that can degrade the hematology measurement.

Novel Direct Oral Anti-Coagulants (DOAC) present additional challenges to clinicians confronted with life threatening bleeding events. Antidotes can be used to reverse the effects of the DOACs, but clinicians are forced to quickly determine if 1) an antidote is needed, and 2) which specific antidote is needed for a particular DOAC. Neither is prophylactic administration of an antidote a welcome alternative considering the cost per dose often exceeds $10,000. In instances where a bleed patient is incapacitated or unable to identify whether a DOAC was ingested, clinicians need a diagnostic device to quickly evaluate the presence of one or more DOACs.

The hematology system can consist of a first hematology capillary with a first hematology pad that can contain a dry DOAC antidote, and a second hematology capillary with a second hematology pad that can contain no dry DOAC antidote. The first hematology capillary can contain whole blood with dissolved hematology reagents and dissolved antidote. The second hematology capillary can contain whole blood with dissolved hematology reagents and no dissolved antidote. Whole blood from the first hematology capillary can clot in less time than whole blood from the second hematology capillary. The hematology system can measure a delta clotting time, which can be the difference in time between the clotting of whole blood in second hematology capillary and the clotting of whole blood in first hematology capillary. An elevated delta clotting time can indicate the presence of a DOAC for which the antidote is specific. An elevated delta clotting time can indicate the presence of a DOAC in whole blood. The presence of a DOAC can be indicated by a delta clotting time of over 0.1 seconds, 0.5 seconds, 1 second, 2 seconds, 5 seconds, 10 seconds, 20 seconds, 30 seconds, 45 seconds, 1 minute, 2 minutes, 3 minutes, 5 minutes, 10 minutes or more. The value of the delta clotting time can represent the concentration or activity of the DOAC.

A hematology pad 153 or a filter can be placed in the fluidic path to an electrochemical sensor. A first hematology pad can contain a DOAC antidote and can be configured to allow whole blood to flow to electrochemical sensor 1. A second hematology pad can contain no DOAC and can be configured to allow whole blood to flow to electrochemical sensor 2. Electrochemical sensors 1 and 2 can be configured to measure a delta clotting time.

The hematology system can measure red blood cell count, hematocrit, mean corpuscular volume, mean corpuscular hemoglobin, mean corpuscular hemoglobin 13 concentration, red cell distribution width, white blood cell count, white blood cell differential, platelet count, prothrombin time, presence of DOACs and others.

Reader 100 can have a separate port for the hematology system. The hematology system can have a second inlet 149 that is fluidically connected to a second hematology pad. The second inlet 149 can be used to deposit whole blood, urine or other fluids. The hematology system can be configured to perform urinalysis.

### Other Sensors

Disposable 1 can integrate additional detection ICs or ICs with multiple detection modalities. IC 9 can integrate additional detection ICs or ICs with multiple detection modalities. The additional detection ICs can be integrated on PCB 3, or on AOW4. An additional detection IC can be an electrochemical IC containing electrochemical sensors that can function either in plasma or whole blood. Platinum electrodes and permselective films can be patterned on a separate electrochemical IC to enable electrochemical sensing on disposable 1. Ion selective electrodes (ISE) can be integrated in the electrochemical IC. ISEs can be used to quantify electrolytes such as sodium, potassion and chloride. An additional detection IC can be an immuno-assay IC. An immuno-assay IC can be a magnetic sensing IC 83 that performs magnetic particle labeled immuno-assays, wherein magnetic particles 98 can be conjugated to antibodies, antigen or other ligands and can capture soluble target proteins or other target analytes in plasma 17. The surface of the magnetic sensing IC 83 can be coated with antibodies, antigen or other ligands. The magnetic particles 98 can sediment via gravity or magnetic forces to the surface of the magnetic sensing IC 83 to which they can bind strongly in the presence of the target proteins or target analyte. Magnetic sensing IC 83 can integrate current carrying conductors adjacent to magnetic particle sensors. The current carrying conductors can remove magnetic particles weakly bound to the surface of the magnetic sensing IC 83 from atop the magnetic particle sensors, while the magnetic particles sensors can detect magnetic particles that remain strongly bound to surface of the magnetic 8 sensing IC 83 above magnetic particle sensors. Magnetic particles can be loaded and stored in a dry state in a well 19. Plasma 17 can rehydrate and release the dried magnetic particles which incubate with plasma 17, capture the target proteins and sediment to the surface of the magnetic sensing IC. The magnetic particles can be dried in a filter or in a capillary. The magnetic particles can be dried on the bottom of a filter. The magnetic particle sensors can be implemented as photodetectors 8 or as magnetic sensors embedded in the magnetic sensing IC 83. Disposable 1 can contain multiple IC 9, additional detection ICs to perform chemistry tests and to perform immuno-assays. Disposable 1 can contain one or more IC 9, one or more electrochemical ICs and one or more magnetic sensing ICs. Electrochemical IC and magnetic sensing IC 83 can be integrated on or parallel or flush with PCB 3. IC 9, electrochemical IC and magnetic sensing IC can have digital interfaces for communication like I²C or SPI. One IC in disposable 1 can be the master IC. IC 9 can be the master IC. The master IC can contain the processor, the memory, or the power management. The master IC can communicate and coordinate with all other IC in disposable 1.

Disposable 1 can have a plurality of electrochemical sensors inserted into a plurality of connectors. Disposable 1 can have a plurality of electrochemical sensors mounted on PCB 3. The electrochemical sensors can be bonded on PCB 3 using epoxy or tape. The leads on the electrochemical strips can be wire-bonded to PCB 3. Electrochemical strips can be planarize to the surface 11 of PCB 3. An inlet capillary 144 can deliver whole blood or plasma directly onto an electrochemical sensor. The electrochemical sensor can measure glucose, ketones, BUN, creatinine, lactate and prothrombin time.

Disposable 1 can be configured to perform a general chemistry biomarker measurement with less than 10 uL of whole blood. Disposable 1 can be configured to perform an immuno-assay biomarker measurement with less than 10 uL of whole blood Disposable 1 can be configured to perform a hematology biomarker measurement with less than 10 uL of whole blood. Disposable 1 can be configured to perform a general chemistry biomarker measurement, an immuno-assay biomarker measurement and a hematology biomarker measurement. Disposable 1 can consume less than 50 uL, 30 uL, 20 uL, 10 uL, 5 uL, 3 uL, 2 uL or 1 uL of whole blood.

The blood analysis system that can include disposable 1 and reader 100 can perform a general chemistry biomarker measurement, an immuno-assay biomarker measurement and a hematology biomarker measurement. The blood analysis system that can include disposable 1 and reader 100 can consume less than 50 uL, 30 uL, 20 uL, 10 uL, 5 uL, 3 uL, 2 uL or 1 uL of whole blood.

### Sample

Sample 18 can be applied on the inlet cuvette 140, inlet 66 or directly on filter 2. Filtrate 24 can be sample 18 filtered through filter 2. Filtrate 24 can contain dissolved reagents 33. Filtrate 24 can flow through filter 2 and onto surface 11. Filtrate 24 can flow on surface 11 as a result of hydrophilic reagents 31 or as a result of the hydrophilicity of surface 11. Filtrate 24 can flow or sheet or wick across surface 11. Filtrate 24 can flow or sheet or wick across gap 12 into capillary 22. Filtrate 24 can flow through surface capillary 22. Filtrate 24 can fill well 19. Protrusion 50 or output lens 51 can contact filtrate 24. Cover 64 can contact filtrate 24. Spectrophotometer 15 can measure the absorbance of filtrate 24 in well 19. Plasma 17 is one example of filtrate 24, wherein sample 18 is whole blood 16. Spectrophotometer 15 can measure the absorbance of fluid in well 19. Filtrate 24 can be defined as any fluid in well 19. Filtrate 24 can be plasma 17.

Sample 18 can be whole blood, serum, plasma, saliva, mucus, pulmonary fluid, feces, cerebral fluids, oral swab collections, nasal swab collections, pulmonary lavages, nasopharyngeal swab collections, gum scrapings or other fluids or secretions, dilutions, elutions, or dissolutions thereof.

Disposable 1 can be used for detecting or measuring multiple types of analytes 36. Analyte 36 can be one or more Ribonucleic acid (RNA) or Deoxyribonucleic acid (DNA) oligonucleotides 110, one or more antibodies 111 or proteins 112, general chemistry biomarkers or electrochemical biomarkers. The presence of oligonucleotides 110 can be indicative of the presence of an active infection of one or a plurality viruses. The titers or the presence of one or a plurality of antibodies 111 can be indicative of one or more past infections of one or more viruses. Disposable 1 can detect the presence of one or more oligonucleotides 110 in sample 18. Disposable 1 can detect the presence or measure the titer of one or more antibodies 111 or proteins in sample 18.

### Reader Implementation

One or more disposables 1 can be inserted into or used with a reader 100. Reader 100 can contain a port 101, a battery 104, a digital display 105, an NFC module 106, a LED 109 and a photodetector 113. Reader 100 can have a plurality of ports, LEDs and photodetectors. Reader 100 can contain a plurality of ports 101 for inserting one or more disposable 1. Battery 104 can be electrically connected to display 105, NFC Module 106 and LED 109. LED 109 can emit light 21 with a narrow band spectrum centered on the optical detection frequency 60. Light 21 from LED 109 can traverse well 19 on disposable 1. Light 21 can be incident on photodetector 113. Reader 100 can measure the absorbance of the filtrate 24 in well 19 in disposable 1. Display 105 can display the absorbance, concentration or activity measurements from disposable 1 or reader 100. NFC Module 106 can communicate with NFC module 42. Reader 100 or port 101 can accept one or a plurality of disposables 1, simultaneously or in series. 19

Reader 100 can be disposable or reusable. Reader 100 can contain a heater 102 and a temperature sensor 108 for maintaining a constant reaction temperature in well 19, for isothermal amplification or general chemistry reactions. Reader 100 can have a plurality of heaters for heating a plurality of disposables to different temperatures. Heater 102 and temperature sensor 108 can be electrically connected to battery 104 or the power management system. Heater 102 can be part of a thermocycler for running a polymerase chain reaction (PCR). The reader 100 can contain a fan, for convective heating or cooling. The reader 100 can have a heat sink or a heater 102 with high surface area to increase heat transfer to air or coolant. The fan and the heat sink can decrease the time necessary to heat or cool the filtrate in well 19 in disposable 1 to a desired reaction temperature.

Reader 100 can retrieve absorbance, concentration or activity measurements from disposable 1 inserted in port 101. Reader 100 can retrieve absorbance, concentration or activity measurements from disposable 1 in proximity to reader 100. Reader 100 can measure the absorbance of the sample 18 or filtrate 24 or plasma 17 in well 19 in disposable 1. Reader 100 can measure the transmittance of the sample 18 or filtrate 24 or plasma 17 in well 19 in disposable 1. Reader 100 can measure the reflectance of the sample 18 or filtrate 24 or plasma in well 19 in disposable 1. Reader 100 can measure the reflectance of the sample 18 or filtrate 24 or plasma 17 in in contact with reflectance surface 81.

Reader 100 or port 101 can contain a digital connector to connect and communicate with disposable 1. Reader 100 or port 101 can contain an RFID transceiver or NFC module that can connect or communicate with the NFC module in disposable 1. Reader 100 or port can contain a camera, image sensor or photodetector that can read display 41 or the output of disposable 1. Reader 100 or port 101 can be configured to allow light 21 from an LED 109 integrated on reader 100 to pass through well 19 on disposable 1. Reader 100 or port 101 can be configured to allow light 21 from an LED 109 integrated on reader 100 to reflect off reflectance surface 81 and be incident on photodetector 113. Reader 100 or port 101 can be configured to allow light 21 to pass through well 19 on disposable 1 and to be incident on photodetector 113 integrated on reader 100. Reader 100 or port 101 can contain one or a plurality of windows, openings or apertures 116 that can allow all or a fraction of light 21 to pass from LED 109 through well 19 and into photodetector 113. Aperture 116 can be a hole in material opaque to light 21. The hole or aperture 116 can be smaller than 2 mm, 1 mm, 0.75 mm, 0.5 mm, 0.4 mm, 0.3 mm or 0.25 mm in diameter. Aperture 116 can be any shape.

Reader 100 or port 101 can operate at one or two or three or more optical detection frequencies 60. Different ports in reader 100 can operate at different optical detection frequencies 60. Reader 100 can be configured such that disposables operating at one optical detection frequency 60 may not be inserted into a second port that operates at another optical detection frequency. Reader 100 can have a reflector 114 that can redirect light 21 from LED 109 through a plurality of wells 19 and onto one or a plurality of photodetectors 113. Reflector 114 can redirect light 21 from LED 109 through a plurality of wells 19 in a plurality of disposables 1 and onto one or a plurality of photodetectors 113. Reader 100 can have a plurality of identical LEDs 109 wherein light from one LED 109 traverses one or more wells on disposable 1. Reader 100 can have a plurality of LEDs 109 emitting light 21 with different optical detection frequencies 60. Reader 100 can have a plurality of photodetectors 113 wherein each photodetector 113 can detect light 21 passing through one or more wells 19 in one or more disposables 1. Reader 100 can have an optical diffuser 115 to provide uniform illumination into one or more wells on disposable 1, or through one or more wells on a plurality of disposables 1. Aperture 116 can be above, below or lateral to disposable 1 and well 19. A plurality of apertures 116 can be in proximity to disposable and well 19. Two apertures can be on either side of well 19. Photodetector 113 can be bigger or smaller than aperture 116. Diffuser 115 can be bigger or smaller than aperture 116. Aperture 116 can be bigger or smaller than the diameter or aperture of well 19. The difference between the amount of power of light 21 transmitted through well 19 and well 7 can be less than 20%, 15%, 10%, 8%, 7%, 6%, 5%, 4%, 3%, 2%, or 1%. The difference between the amount of power of light 21 transmitted through well 19 containing a control sample from a first disposable 1 and the amount of power of light 21 transmitted through well 19 containing a control sample from a second disposable 1 can be less than 20%, 15%, 10%, 8%, 7%, 6%, 5%, 4%, 3%, 2%, or 1%. Reader 100 can perform rate or endpoint absorption measurements of chemical reaction 35 in well 19.

Reader 100 can have blinds 121 positioned between each well 19 to optically isolate the wells from one another. Reader 100 can have blinds 121 positioned between each LED 109 to optically isolate the LEDs from one another. Reader 100 can have blinds 121 positioned between different paths of light 21 to optically isolate the different light paths from one another. The blinds 121 can contact disposable 1 or well 19. The blinds 121 can be in proximity to disposable 1 or well 19. Cross illumination can occur wherein light 21 intended to pass through one well passes through an adjacent well. Cross illumination can occur wherein light intended to be incident on one photodetector is incident on an adjacent photodetector. Reader 100 can correct for cross illumination numerically. Reader 100 can contain one LED per well, wherein the pitch of the LEDs is approximately equal to the pitch of the wells. Reader 100 can employ one photodetector per well, wherein the pitch of the photodetectors is approximately equal to the pitch of the wells.

Reader 100 or port 101 can have blinds between wells, wherein the pitch of the blinds is approximately equal to the pitch of the wells. Reader 100 or port 101 can contain one aperture per well, wherein the pitch of the apertures is approximately equal to the pitch of the wells. Reader 100 or port 101 can contain two apertures per well, on either side of the well, wherein the pitch of the apertures is approximately equal to the pitch of the wells. Reader 100 can power a plurality of LEDs 109 at one time, or reader 100 can power a plurality of LEDs 109 in sequence.

Reader 100 can communicate to clinic or hospital information system. Reader 100 can be connected physically or wirelessly to the clinic or hospital information system. Disposables can communicate with each other or to reader 100 via I2C, SPI, RFID or other digital interfaces. Disposables can communicate with each other via the reader. The reader can connect to other readers. Multiple readers connected together can share a single power source or power supply. The power source could be battery 104 or a power outlet connection. Multiple readers connected together can share a single connection to the clinic or hospital information network. Reader 100 can have a case that can contain slots to connect to other readers. The case can contain electrical leads for supplying power and information. Reader 100 can be a mobile device such as a laptop, tablet or phone.

Reader 100 or port 101 can have physical registrations points or features to hold disposable 1 at a preset position with respect to reader 100 or port 101. Disposable 1 can have physical registrations points or features to align disposable 1 at a preset position with respect to reader 100 or port 101. Reader 100 can have features so disposable 1 can be securely inserted into or removed from port 101. Reader 100 or port 101 can have a mechanical slide or mechanical guide to insert and remove disposable 1 from port 101. The mechanical guide can assist inserting disposable 1 in port 101 or reader 100. The shape of port 101 can be complementary to the shape of disposable 1. Port 101 can have a swinging or sliding door through which disposable 1 can be inserted. The door or opening on port 101 or reader 100 can block light from entering inside port 101 or reader 100. The position of disposable 1 inserted into port 101 can vary less than 250 μm, 100 μm, 50 μm, 25 μm, 10 μm, 5 μm from a nominal position.

The reader 100 can detect if disposable 1 is inserted in port 101. The reader 100 can contain detection apparatus wherein the detection apparatus can detect when disposable 1 is inserted in port 101. The reader can use LED 109 and the photodetector 113 to detect the presence of disposable 1 at or near a nominal position in port 101. The amount of light 21 from the LED 109 incident onto the photodetector 113 can indicate whether disposable 1 is inserted in port 101 at or near a nominal position. Disposable 1 and reader 100 can contain a male or female edge connector. Reader 100 can contain a USB interface or Bluetooth connection to communicate with a smartphone.

### Cartridge Implementation

Surface 11 can be transparent. Surface 11 of disposable 1 can be constructed from a plastic transparent to light 21. Surface 11 can be glass or plastic and can be coated with a protein adhesion layer. Surface 11 can be perpendicular to the path of light 21 from LED 109 or LED 5 to photodetector 8 or photodetector 113. Light 21 can be incident on surface 11. Surface 11 can transmit light 21.

Well 19 can have two opposing flat inner surfaces that transmit light 21. Light 21 can travel perpendicularly through two surfaces that form inner surface of well 19. Surface 11 can be an inner surface of well 19. Cover 64 can be an inner surface of well 19. The two opposing inner surface can have different shapes. One inner surface can be the output lens 51. Another inner surface can be surface 11. Light 21 from LED 109 can be redirected by reflector 114 or reflector 6, incident on one or more inner surfaces of well 19 and incident on photodetector 113. The AOW 4 can be transparent or opaque. The cross sectional top view of well 19 can be circular, rectangular or any other shape. The cross sectional side view of well 19 can be circular, rectangular or any other shape.

Light 21 can traverse well 19 in disposable 1 laterally to avoid bubbles generated by heating or by imperfect capillary flow. Bubbles in well 19 can percolate to the top of well 19. Light 21 can traverse laterally through well 19 below the bubbles. Wells on the same disposable 1 or well on different disposables can be in different orientations. The path of light taken by light 21 through the filtrate 24 in well 19 can be vertical. The path of light taken by light 21 through the filtrate 24 in well 19 can be horizontal or lateral. Control wells can be used to determine the background signals for disposable 1. Control wells can be used to determine the background signals for disposable 1 for filtrate 24 or plasma 17. Control wells can be used as one point in an endpoint measurement. The results from reader 100 or 27 disposable 1 can be qualitative, indicating the presence or absence of one or more analytes.

A vial 103 can be mounted to AOW 4, surface 11, filter 2, tape 10 or other feature on disposable 1. The vial 103 can be twisted, popped, pushed, friction fit onto AOW 4, surface 11, filter 2, tape 10 or other feature on disposable 1. Vial 103 can have a seal on the bottom configured to open and release the contents of vial 103 when vial 103 is mounted, twisted, popped, pushed or friction fit. A user can add a sample 18 into vial 103. Sample 18 in vial 103 can be mixed and diluted. A user can mount vial 103 on disposable 1. Vial 103 can contain a buffer or diluent necessary for running reaction 35. The vial 103 can contain dried reagents. The vial 103 can have a lid that a user need to remove to add sample 18 or a swab of a sample 18. Vial 103 can contain a buffer solution or diluent for diluting one or more samples 18 or whole blood 16. Filter 2 below vial 103 can be a porous material impregnated with filter reagents 32.

### Immunoassay Detection

Reader 100 can read a lateral flow strip. The results from the lateral flow strip can be interpreted visually by reader 100. Reader 100 can contain one or a plurality of optical detectors, photodetectors, imaging system or cameras to detect and measure the test and control lines of a lateral flow strip. A lateral flow strip can be inserted into port 101. Disposable 1 can contain a magnetic sensing IC 83 and can use magnetic particles to bind to one or a plurality of target analytes. Magnetic sensing IC 83 can be integrated into IC 9. Disposable 1 or magnetic sensing IC 83 can contain a surface 11 onto which magnetic beads can bind specifically. Reader 100 can contain one or more magnets 117 that can be configured to generate the magnetic forces to remove the non-specifically bound magnetic particles from surface 11. Magnet 117 can be a permanent magnet or an electromagnet. Reader 100 can have a linear motion system to move magnet 117 in proximity to well 19. Reader 100 can have a swing arm to move magnet 117 in proximity to well 19. Magnet 117 can be stationary in reader 100 and disposable 1 can be mobile.

Disposable 1 can be moved in proximity to magnet 117. Magnet 117 can be above, below or to the side of disposable 1 and well 19. Magnet 117 can be in proximity to well 117. Magnet 117 can be above well 19 and pull non-specifically bound magnetic particles up off surface 11. Magnet 117 can be positioned laterally to well 19 and pull non-specifically bound magnetic particles up laterally across surface 11. Reader 100 can contain an imaging system 118 to detect, count, estimate or measure the number of magnetic particles are specifically bound to surface 11. The imaging system 118 can use direct illumination, backlit illumination or total internal reflection to detect magnetic particles that can be specifically bound on surface 11, or cells or other particles. The imaging system 118 can use near-field or far-field optical detection of magnetic particles on surface 11, or cells or other particles. Imaging system 118 can have pixels to detect magnetic particles, cells or magnetic particles. Surface 11 can adhere to antibodies or antigen or be coated with an adhesion layer that can adhere to antibodies or antigen. Antibodies and antigens can be bound to the adhesion layer. The adhesion layer can be a thin layer of gold coated or deposited on surface 11 of the magnetic sensing IC 83. The surface of magnetic sensing IC 83 can be surface 11. The wells in disposable 1 can be placed vertically or effectively vertically such that magnetic particles can settle to surface 11 due to gravity. 8

Magnetic particles can be pulled towards surface 11 by a permanent magnet or electromagnet.

The magnetic sensing IC 83 can be manufactured on a wafer. A thin layer of gold acting as the protein adhesion layer can be deposited directly onto the magnetic sensing IC wafer through vacuum, electron beam or sputtering deposition. The pads can be protected with a shadow mask. A protective layer can be applied to the gold layer prior to wafer dicing, and can be removed prior to coating with antibodies and antigen. Alternatively, antibodies and antigen can be coated directly onto the protein adhesion layer on magnetic sensing IC wafer. The pads of the magnetic sensing IC 83 can be protected with photoresist during the protein 17 adhesion layer deposition or the antibody or antigen coating processes. The proteins can be protected using photoresist during the wafer dicing process. 19

The surface or the adhesion layer or surface 11 can be coated with one or more viral antigens or with antibodies against a virus. Disposable 1 can perform a sandwich capture immunoassay or a competitive immunoassay. Magnetic particles can be dried in filter 2 or prefilter 59 or on surface 11 or the surface of lens 51. The surface 11 or adhesion layer can be coated with angiotensin converting enzyme 2 (ACE2) proteins. More than one surfaces or regions of the same surface 11 of disposable 1 can be coated with different epitopes of the ACE2 protein. The surface or adhesion layer can be coated one or more spike proteins (S proteins). A plurality of surfaces or regions on one surface can be coated with different S proteins that bind to different regions of ACE2. Disposable 1 can detect or measure the presence of virus proteins in a sample, or disposable 1 can detect or measure the presence of antibodies to the virus in the sample.

Disposable 1 can detect multiple different isotypes from a sample, for example, Immunoglobulin G (IgG) and Immunoglobulin M (IgM) specific to a strain of a virus. Disposable 1 can detect multiple strains of a virus in a simplex format, wherein the presence of any of the strains yields a positive. Disposable 1 can detect multiple strains of a virus independently in a multiplexed format. Disposable 1 can detect different isotypes in a simplex format wherein the presence of any of the isotypes yields a positive. Disposable 1 can detect different isotypes individually in a multiplexed format. Chemical reaction 35 can be an antibody antigen binding reaction.

The magnetic particles can be dried on the surface of protrusion 50, lens 51 or cover 64. Magnetic particles coated with a plurality of proteins can be loaded on a plurality of filters, wells, surface or lenses. Each filter or well can have magnetic particles coated with one type or set of proteins, wherein multiplexed assays can be performed in a plurality of wells. Magnetic particles coated with a plurality of proteins can be loaded on a plurality of locations on surface 11. Each location on surface 11 can have magnetic particles coated with one type or set of proteins, wherein multiplexed assays can be performed in a plurality of wells. Magnetic particles coated with a plurality of proteins can be loaded on a plurality of wells or output lenses. Each well can have magnetic particles coated with one type or set of proteins, wherein multiplexed assays can be performed in a plurality of wells.

### Oligonucleotide Detection

Chemical reaction 35 can be an amplification chemical reaction. Disposable 1 can perform an amplification chemical reaction. An amplification chemical reaction can amplify RNA or DNA, through reverse transcriptase loop mediated isothermal amplification (RT LAMP), loop mediated isothermal amplification (LAMP), or other forms of isothermal amplification, Polymerase Chain Reaction (PCR) or Real Time (RT) PCR. The product or reactant of the amplification chemical reaction can contain a reporter molecule 56 that can be detected and their concentration measured spectroscopically by spectrometer 15 or by reader 100. Disposable 1 can contain amplification reagents 120 in a wet or dry state. The amplifications reagents 120 can comprise primers, polymerase enzymes, detergents and drying excipients. The amplification reagents can be in the vial, prefilter reagents 54, filter reagents 32, surface reagents 30, additional reagents 37 or diluent reagents 119. The amplification reagents 120 can be dried. The diluent in vial 103 can have diluent reagents 119 necessary to perform an isothermal amplification chemical reaction. The diluent in vial 103 can have diluent reagents 119 necessary to perform a chemical reaction 35.

The sample 18 can be mixed with the diluent and diluent reagents 119 and introduced onto the filter 2 or prefilter 59. The filtrate 24 can enter well 19. The IC 9 can heat well 19 to the needed isothermal amplification temperature, like 65, 70, 75, 80 degrees Celsius or other temperatures. A separate heater on disposable 1 can heat well 19 to the needed isothermal amplification temperature, like 65, 70, 75, 80 degrees Celsius or other temperatures. The reader 100 can have a heater 102. Reader 100 or heater 102 can heat well 19 to the needed isothermal amplification temperature, like 65, 70, 75, 80 degrees Celsius or other temperature. The amplification temperature can be thermocycled to perform PCR.

For well inner volumes exceeding 1 μL, a plurality of ICs with a single well 19 can be integrated into and co-planar with PCB 3.

### Communication

Disposable 1 can have a near field communication (NFC) module 42 to communicate with reader 100, a mobile device or a laboratory information interface. The NFC module 42 can comprise an antenna and a transceiver IC. The antenna and transceiver IC can be mounted on PCB 3 or can connect to PCB 3. The antenna can be formed by traces on PCB 3. The antenna can be printed on or adhered to the bottom side of top housing 91. The antenna can be printed on or adhered to the top side of the bottom housing 92. The antenna can be electronically connected to NFC module 42. IC 9 can be electrically connected to NFC module 42. IC 9 can integrate the transceiver IC. Disposable 1 can transmit or receive assay information via the NFC module 42. Stored information can comprise assay information. Assay information can be the serial number of disposable 1, the time needed for disposable 1 to analyze sample 18, the time and date, the species of animal providing the sample, the age of the patient or animal. Assay information can be the measurements results or error codes resulting from disposable 1 analyzing sample 18 or whole blood 16. NFC module 42 can contain non-volatile memory. The non-volatile memory on NFC module 42 can store assay information or stored information. The non-volatile memory on NFC module 42 can store the program to control disposable 1. The program to control disposable 1 can be transferred from NFC module 42 to IC 9. IC 9 can process assay information stored in the non-volatile memory on NFC module 42. IC 9 can communicate with NFC module 42 via I2C, SPI, RFID or other serial or parallel digital interfaces.

Disposable 1 can be in a powered off state until the NFC module 42 is activated. The NFC module 42 can activate or turn on the power to disposable 1. NFC module 42 can activate or turn on the power to IC 9. NFC module 42 can activate or turn on the power to the power management or the power control system for disposable 1. The NFC module can be in a power 6 down state. The NFC module can be activated or turned on by the proximity of another NFC module. Disposable 1 can be activated or turned on by bringing another NFC module in proximity. Disposable 1 can be activated or turned on by the proximity of another NFC module. Disposable 1 can be activated or turned on by a radio frequency signal. Disposable 1 can have an electronic latch that changes state in proximity to another NFC transceiver. Disposable 1 can have an electronic power switch that changes state in proximity to another NFC transceiver. NFC module 42 can change the state of an electronic power switch. NFC module 42 can be integrated on IC 9. The electronic latch and power switch and the power management or power control system can be integrated on IC 9.

Disposable 1 can have an indicator LED to inform the user the state of the disposable. The indicator LED can be on, off, and it can be modulated between on and off in a pattern. The state and the pattern of the indicator LED can represent the state of disposable 1. The state of disposable 1 can be off, on, awaiting sample, processing sample, requesting more sample, analysis complete and error.

### Optic Cavity

Reflector 6 can be mounted on AOW 4 using an optic tape 67. Optic tape 67 can be a double sided tape. Optic tape 67 can have a channel or optic tape vent 68 to let air or filtrate pass. Optic tape 67 can have a plurality of optic tape vents 68. Optic tape 67 can have one optic tape vent 68 for every well 19 on AOW 4 in disposable 1. One or a plurality of surfaces of the optic tape vent 68 can be hydrophobic or coated with a hydrophobic reagent. One or a plurality of surfaces of the optic tape vent 68 can be hydrophilic or coated with a hydrophilic reagent. Optic tape vent 68 can resist the flow of filtrate 24 or plasma 17. Optic tape vent 68 can promote the flow of filtrate 24 or plasma 17.

Evaporation can be big problem for the reaction 35 as it can force accumulation of the reporter molecule 56 in filtrate 17. Vent 52, vent 68 or surface capillary 22 can be lengthened to eliminate or reduce mass transport of air or water or reporter molecule 56. Vent 52, vent 68 or capillary 22 can be longer than 1 mm, 2 mm, 3 mm, 4 mm, 5 mm, 6 mm, 7 mm, 8 mm, 9 mm or more than 10 mm. One metric for reducing mass transport is length divided by cross sectional area. The length divided by the cross sectional area of vent 52, vent 68 or capillary 22 can be greater than 100*m⁻¹, 1000*m⁻¹, 10000*m⁻¹, 100000*m⁻¹, 1000000*m⁻¹, or 10000000*m⁻¹.

Cover 64 can have a protrusion 50 and a lens 51 that can contact the plasma 17 or filtrate 24 in well 19 first to avoid the creation of bubbles. Cover 64 can be the output lens 51 of reflector 6. Cover 64 or reflector 6 can have an optical cavity 69. An optical cavity 69 can 8 be a pocket of air between reflector 6 and AOW 4 or between cover 64 and AOW 4. Optical 9 cavity 69 can be formed by optical tape 67. The optical cavity 69 can be a light guide that guides or concentrates light 21 to the output lens 51. The optical cavity 69 can be a light guide 11 that guides or concentrates light 21 from an optical element in reflector 6 to the output lens 51. Optical cavity 69 can have a conical shape 70. Conical shape 70 can be above well 19 and lens 51. Light 21 can pass through conical shape 70 before lens 51 or well 19. The conical shape 70 can concentrate light 21 onto output lens 51. The conical shape 70 can direct light 21 that is not incident on output lens 51 away from the aperture at the top of well 19. The conical shape 70 can reduce or eliminate the amount of light 21 entering well 19 that is not incident on output lens 51. The conical shape 70 and output lens 51 can minimize the variation in path length 39. Output lens 51 can be flat. Cover 64 can have an optical cavity 69 with a conical shape 70 and an output lens 51. The optical cavity 69 can eliminate the existence on bubbles between the output lens 51 and the filtrate 24 or plasma 17 in well 19. The optical cavity 69 can permitting output lens 51 to contact plasma 17 or filtrate 24 in well 19 and can prevent plasma 17 or filtrate 24 in well 19 from wicking into optical cavity 69. Optical cavity 69 can be a fluidic stop gap that can prevent plasma 17 or filtrate 24 in well 19 from flowing into optical cavity 69 or into optic tape vent 68. The inner surface of optical cavity 69 can be hydrophobic or coated with a hydrophobic coating to avoid condensation from plasma 17 or filtrate 24 in well 19. The inner surface of cavity 69 can be polished to reduce or avoid condensation from plasma 17 or filtrate 24 in well 19. The inner surface area of cavity 69 can be minimized to reduce or avoid condensation from plasma 17 or filtrate 24 in well 19. Reflector 6 can be constructed from a hydrophobic material.

### Filter Module

Filter 2 and prefilter 59 can be laminated into a filter module 71. Filter module 71 can comprise a filter 2, a prefilter 59 and one or a plurality of lamination surfaces 84. Prefilter 59 can be a porous membrane impregnated with prefilter reagents 54. Prefilter 59 can touch or crush filter 2 to ensure proper flow of sample 18, whole blood 16, plasma 17 or filtrate 24 from prefilter 59 into filter 2. Prefilter 59 can be fluidically connected to filter 2. Prefilter 59 can have larger or smaller pore size than filter 2. Prefilter 59 can have similar pore size to filter 2. Filter 2 or prefilter 59 can block red blood cells from passing while allowing plasma 17 to pass. 8

Filter module 71 can comprise one or a plurality of sample bypass stops 84. A sample bypass stop 84 can be a feature that restricts or blocks the passage of whole blood 16 or sample 18 from inlet 66 into surface capillary 22 without traversing filter module 71 or filter 2. A sample bypass stop 84 can be a feature that ensures passage of whole blood 16 or sample 18 through filter module 71 or filter 2. A sample bypass 84 can be gap 12, barrier 13 or a notch in filter 2 or prefilter 59. Filter 2 and prefilter 59 can be laminated on a lamination surface 84. Lamination surface 84 can be a pressure sensitive adhesive, a transfer adhesive, or other flat material.

Lamination surface 84 can adhere to filter 2 or prefilter 59 and hold them in contact with each other. Lamination surface 84 can be placed flat on surface 11, PCB 3 or tape 10.

Lamination surface 84 can be a sample bypass stop 84. Lamination surface 84 can be hydrophobic. The backing of lamination surface 84 can be hydrophobic. Lamination surface 84 can have portions that are hydrophobic. Lamination surface 84 can have an adhesive that is hydrophobic such as a silicone adhesive. Lamination surface 84 can have a cut edge that is hydrophobic. One or a plurality of edges of lamination surface 84 can be aligned with one or a plurality of the edges of filter 2 or prefilter 59. Lamination surface 84 can have a thickness. The thickness of lamination surface 84 can be greater than 5 μm, 10 μm, 15 μm, 25 μm, 50 μm, 100 μm, 200 μm or 500 μm. The thickness of lamination surface 84 can be less than 5 μm, 10 μm, 15 μm 25 μm, 50 μm, 100 μm, 200 μm or 500 μm. Lamination surface 84 can be placed in between surface 11 or tape 10 and filter 2 or prefilter 59. Lamination surface 84 can prevent the sample 18 in filter 2 or prefilter 59 from flowing onto or contacting surface 11 or tape 10. Lamination surface 84 can block, control or reduce sample bypass.

Filter module 71 can have two or more lamination surfaces. Filter module 71 can have a first lamination surface 84 on the bottom and a second lamination surface 85. Lamination surface 85 can be positioned on the top of filter module 71. Lamination surface 85 can be a sample bypass stop. Lamination surface 85 can promote passage of sample 18 or whole blood laterally through filter 2 or prefilter 59. Lamination surface 85 can promote incubation of sample 18 or whole blood 16 with filter reagents 32 or prefilter reagents 54. The dimensions of lamination surface 85 can modulate the amount of sample 18 and whole blood 16 incubate with filter reagents 32 or prefilter reagents 54. Lamination surface 85 can reduce or eliminate passage of sample 18 or whole blood 16 over or around filter 2 or prefilter 59. Lamination surface 85 and lamination surface 84 can overlap across a section of module 71 to ensure sample 18 or whole blood 16 wick laterally through filter 2 or prefilter 59 and dissolve the 11 appropriate amount of filter reagents 32 or prefilter reagents 54. A portion of filter 2 or 12 prefilter 59 in filter module 71 can be mounted directly onto surface 11 or tape 10, without lamination surface 84 in between. A portion of filter 2 or prefilter 59 can be exposed, without lamination surface 85 above it so it can be crimped, or notched. A portion of filter 2 or prefilter 59 can be exposed, without lamination surface 85 above it so that a barrier 13 can be integrated. A portion of filter 2 or prefilter 59 can be exposed, without lamination surface 85 above it so that it can be placed under AOW 4.

Filter module 71 can be manufactured or laminated in a long filter module strip. The filter module strip can comprise a filter material strip, a prefilter material strip, a first lamination surface strip and a second lamination surface strip. The filter module strip can be singulated by scissors, guillotine or slitter into individual filter modules 71. The length of the filter module 71 can be determined by the width of the filter module strip width. The length of the filter module 71 can be less than 10 mm, 9 mm, 8 mm, 7 mm, 6 mm, 5 mm, 4 mm, 3 mm, 2 mm or 1 mm. The edges of the lamination surfaces 84 and 85 can be aligned to the edge of the filter 2 and/or the edge of prefilter 59. The singulation of the filter module strip can align the edges of the lamination surfaces 84 and 85 and the edge of the filter 2 and/or the edge of prefilter 59. The edges of filter 2 and prefilter 59 can be aligned. The singulation of the filter module strip can determine the width of the filter module 71. The width of the filter module 71 can be less than 10 mm, 9 mm, 8 mm, 7 mm, 6 mm, 5 mm, 4 mm, 3 mm, 2 mm or 1 mm. The filter module strip can be manufactured by standard lamination processes. The filter module strip can be manufacturing by layering or overlapping a filter material strip, a prefilter material strip and a first and second lamination surface material strip. The filter module strip can be manufactures in a web-to-web process wherein the filter material strip, prefilter material strip, first lamination surface material strip and second lamination surface material strip are overlapped and laminated in a continuous web-to-web process. A roller or press can crush the prefilter material strip into the filter material strip, either before or after either one or both first and second surface lamination material strips are laminated. A roller or press can adhere one or a plurality of lamination material strips to the prefilter material strip and/or the filter material strip. Filter module 71 can accept less than 10 μL, 9 μL, 8 μL, 7 μL, 6 μL, 5 μL, 4 μL, 3 μL, 2 μL or 1 μL before filter 2 or prefilter 59 or filter module 71 becomes saturated. A crimp or notch to create barrier 13 can be added into filter 2 of filter module 71 before the filter module strip is singulated. The crimp or notch acting as barrier 13 can be made by a press or a drum or a roller. The depth of the crimp or notch or barrier 13 can be controlled by a precise mechanical spacer.

Filter module 71 can comprise a filter 2 with first and second lamination surfaces 84 and 85, without a prefilter 59. Filter module 71 can comprise a plurality filters and prefilters. Filter 2 or prefilter 59 can be whole blood filters. Prefilter 59 can be a sintered plastic material. Prefilter 59 can distribute sample 18 or whole blood 16 evenly across filter 2. Filter 2 or prefilter 59 can be impregnated with an amino acid, such as alanine, glycine or aspartate to promote the separation of plasma 17 from whole blood 16. Filter module 71 can contact AOW 4. Filter module 71 can be separated from AOW 4 by a gap 12. Filter module 71 can be above surface 11 or tape 10. Filter module 71 can be mounted on surface 11 using tape 10.

Filter module 71 or filter 2 can have a plurality of barriers 13. Filter module 71 or filter 2 can have a first barrier 13 around part or all of its perimeter. The first barrier 13 can prevent whole blood cells from leaking out the side of filter module 71 or filter 2 onto surface 11 or tape 10 or into surface capillary 22. The first barrier 13 can be a crimp or a notch or a hydrophilic coating. The crimp generating the first barrier 13 can be applied after the filter module 71 or filter 2 are applied on surface 11 or tape 10. Filter module 71 or filter 2 can have a second barrier 13 on a portion of filter module 71 or filter 2. The second barrier 13 can be a crimp or a notch or a hydrophobic coating. The second barrier 13 can contact AOW 4.

Filter module 71 can be separated from AOW 4 by a gap 12. Filter module 71 or filter 2 can be in contact with AOW 4. Filter module 71 or filter 2 can be under AOW 4. Filter module 71 or filter 2 can be between surface 11 or tape 10 and AOW 4. The second barrier 13 can be between surface 11 or tape 10 and AOW 4. AOW 4 can crush or overlap filter module or filter 2 in a crush region. Channel 25 can have an enlargement 86 around the crush region wherein AOW 4 crushes or overlaps filter 2 or filter module 71. The enlargement 86 can allow plasma 17 or filtrate 24 to circumvent the region. Channel 25 can be wider than the crush region. The crush region can promote the wicking of plasma 17 or filtrate 25 into surface capillary 22. A corner of AOW 4 can crush filter 2 or filter module 71 to minimize the crush 9 region. The crush region can be smaller than 9 mm², 4 mm², 1 mm² or 0.25 mm². Channel 25 can traverse the region wherein AOW 4 crushes filter 2 or filter module 71. Channel 25 can be below the crush region. AOW 4 can have one or a plurality of extensions 87 that protrude from the portion of AOW 4 that forms the wells. A portion or all of extension 87 can crush or overlap filter 2 or filter module 71 and form the crush region. The extensions 87 can be less than 5 mm, 4 mm, 3 mm, 2 mm, 1 mm, 0.5 mm wide and less than 5 mm, 4 mm, 3 mm, 2 mm, 1 mm, 0.5 mm long. The extensions 87 can facilitate the positioning of the filter 2 or filter module 71 with respect to AOW 4. AOW 4 can have a plurality of extension with different lengths and widths. Disposable 1 can have a plurality of filters 2 or filter modules 71 of different size. Disposable 1 can have a plurality of filters 2 or filter modules 71 of length and width. The shape of filter 2 and filter module 71 can be rectangular or square or a parallelogram.

### Assay Control

Disposable 1 can have a sample electrode 90. Sample electrode 90 can detect the presence of a sample 18, whole blood 16, plasma 17 or filtrate 24 on surface 11, or PCB 3 or IC 9. Sample electrode 90 can be capacitive, wherein sample electrode 90 can detect a change in dielectric constant of the medium in contact with sample electrode 90. Sample electrode 90 can be resistive, wherein sample electrode 90 can detect a change in the resistance of the medium in contact with sample electrode 90. Sample electrode 90 can be acoustic wherein sample electrode 90 can detect a change in the acoustic properties of the medium in contact with sample electrode 90. The medium in contact with sample electrode 90 can be air, sample 18, plasma 17, whole blood 16, filtrate 24 or any other material that constitute disposable 1. Sample electrode 90 can be first exposed to air. Sample electrode 90 be subsequently exposed to sample 18, plasma 17, whole blood 16, filtrate 24. Sample electrode 90 can detect contact with sample 18, plasma 17, whole blood 16, filtrate 24. Sample electrode 90 can detect the transition from one medium to another. Sample electrode 90 can be made of gold, platinum or any other material that can detect contact of sample 18, plasma 17, whole blood 16, filtrate 24. Sample electrode 90 can be made of a material that doesn't corrode. Sample electrode 90 can be on surface 11. Sample electrode 90 can be an exposed pad or lead of PCB 3 or IC 9. PCB 3 or IC 9 can have gold electroplated pads or leads. Sample electrode 90 can be gold electroplated pads or leads. Sample electrode 90 can be positioned under, above, laterally, in contact or in proximity to sample inlet 66, sampling capillary 65, filter module 71, filter 2, channel 25, AOW 4, tape 10, gap 12, capillary channel 22 or IC 9.

Sample electrode 90 can be formed by two pads in proximity. The distance between two pads can be less than 1 mm, 100 μm, 30 μm, 10 μm, 5 μm or 1 μm. Sample electrode 90 can comprise interdigitated pads. One pad of sample electrode 90 can be electrically connected to a resistor. The resistor in contact with one pad of sample electrode 90 can be larger than 1 kΩ, 1 MΩ, 10 MΩ. One pad of sample electrode 90 can be connected to ground or a power supply. The voltage across or current through sample electrode 90 can change when sample 18, whole blood 16, plasma 17 or filtrate 24 is applied. IC 9 or electronics on PCB 3 can detect a change of voltage across or current through sample electrode 90. A change of voltage across or current through sample electrode 90 can turn on or activate disposable 1, IC 9, the power management or the power control system in disposable 1.

Sample electrode 90 can detect the application of sample 18, whole blood 16, plasma 17 or filtrate 24 on disposable 1. Disposable 1 can detect the sample application time corresponding to the application of sample 18, whole blood 16, plasma 17 or filtrate 24 on inlet 66 using sample electrode 90. IC 9 or disposable 1 can record or store the sample application time when the sample 18 was applied. The sample application time can be part of the assay information. Disposable 1 can have a plurality of sample electrodes 90. The information from one or a plurality of sample electrodes can be combined to measure disposable 1 timing information. The timing information from one or a plurality of sample electrodes 90 can be subtracted by IC 9 or disposable 1. Timing information can be assay information. Two sample electrodes can be placed on opposite sides of filter 2 or filter module 71 to measure or estimate the sample dwell time. The sample dwell time can be assay information. Sample dwell time can be the time sample 18, whole blood 16, plasma 17 or filtrate 24 dwells in filter 2 or filter module 71. A sample electrode 90 can be configured to detect an absence of sample after the application of a sample. An electrode 90 can be configured to detect an underfill, wherein insufficient sample is introduced in inlet cuvette 140.

Disposable 1 or system 100 can detect the sample arrival time corresponding with the arrival of plasma 17 or filtrate 24 in well 19. Disposable 1 or system 100 can detect the sample arrival time by detecting the increase in absorbance due to the arrival of plasma 17 or filtrate 24 in well 19. The sample arrival time can be assay information. The sample application time can be subtracted from the sample arrival time to measure, estimate or approximate the sample dwell time. The concentration of dissolved reagents 33 in plasma 17 or filtrate 24 can have a dwell time correlated to the sample dwell time. Dwell time correlation can be assay information. IC 9 or disposable 1 can combine the sample dwell time and dwell time correlation arithmetically to correct the assay measurements for departures from a nominal sample dwell time.

Disposable 1, IC 9 or reader 100 can serially measure the absorbance of the filtrate 24 or plasma 17 in well 19 at high frequency. The high frequency at which disposable 1, IC 9 or reader can serially measure the absorbance of the filtrate 24 or plasma 17 in well 19 can be higher than 1 Hz, 10 Hz, 50 Hz, 100 Hz, or 1 kHz. Serial measurements of the absorbance of the filtrate 24 or plasma 17 in well 19 can be taken at high frequency and can be combined to determine a sample slope. The sample slope can be positive while plasma 17 or filtrate 24 enters well 19, corresponding to an increase in the absorbance of the filtrate 24 or plasma 17 in well 19. The sample slope can become abruptly or highly negative when the filtrate 24 or plasma 17 contacts the protrusion 50 or lens 51, corresponding to the elimination of the reflector 6 to air and air to plasma 17 or air to filtrate 24 interfaces. Disposable 1 or reader 100 can generate a sample slope signal when sample slope breaches a threshold or changes polarity. A sample slope signal can indicate that well 19 is full, that the path length 39 is stable and that the measurement of analyte 36 can proceed. Analyte 36 in filtrate or plasma 17 can be measured in well 19 when a sample slope signal is produced. Disposable 1 or reader can produce a plurality of sample slope signals. Disposable 1 or reader 100 can produce one sample slope signal for each well. The results of disposable 1 can be invalidated if one sample slope signal is not produced. Disposable 1 or reader 100 can prompt a use to provide more sample 18 or whole blood 16 until one or all the sample slope signals are produced. A sample slope can also be employed to measure rate reaction constants and by extension the activity of enzymes. Disposable 1 or IC 9 can contain a data buffer with past absorbance measurements of plasma 17 or filtrate 24 in well 19. Disposable 1 or IC 9 can perform regression analyses on the past absorbance measurements in the data buffer. Examples of regression analyses include least square fits, linear regressions, power law regressions, exponential regressions or other numerical regressions. 8

LED 5 or LED 109 can emit light 21 with varying power. Disposable 1 or reader 100 can have a power reference photodetector. Light 21 can travel from LED 5 or LED 109, can travel through reflector 6 or reflector 114 and light 21 can be incident on the reference power photodetector, without traversing through plasma 17 or filtrate 24. The power reference photodetector can produce a power reference measurement. To mitigate the effects of the varying power of light 21, the power reference measurement can be arithmetically combined with the measurement from photodetector 8 or photodetector 113. The power reference measurement can be subtracted from the measurement of photodetector 8 or photodetector 113. The measurement of photodetector 8 or photodetector 113 can be divided by the power reference measurement.

Disposable 1 can have one or a plurality of power reference photodetectors for each LED 5. Reader 100 can have one or a plurality of power reference photodetectors for each LED 109.

A power reference sensor can be placed on IC 9. A plurality of power reference sensors can be placed on IC 9. One power reference sensor can be placed next to photodetector 8. The AOW 4 can have an opening well over one or more power reference sensors to permit and light can travel from the protrusion 50 or lens 51 to the power reference sensor. The opening or well over the power reference sensor can be fluidically disconnected from the plasma 17.

Disposable 1 can have a plurality of temperature sensors. A temperature sensor can be integrated in IC 9. A temperature sensor can be mounted on PCB 3. Disposable 1 can have a plurality of heaters.

A heater can be integrated in IC 9. A heater can be mounted on PCB 3. A heater can be a resistor with resistance value less than 200Ω, or 100Ω, or 50Ω, or 20Ω, or 10Ω. The one or plurality of heaters on disposable 1 can be controlled in a closed loop using the feedback from temperature measurements from the one or plurality of temperature sensors on disposable 1. The one or plurality of heaters on disposable 1 can be controlled in an open loop using the temperature measurements from the one or plurality of temperature sensors on disposable 1 and heating information stored on disposable 1. The heating information can include look-up tables or predictive models providing the total thermal energy required to reach a desired reaction temperature. Temperature information from the temperature sensors can be used to compensate for any difference between the reaction temperature of reactions 35 and the 8 desired reaction temperature. The one or plurality of heaters on disposable 1 can be configured in an open loop using the temperature measurements from the one or plurality of temperature sensors on disposable 1 and heating information stored on disposable 1 to take reaction temperature of reaction 35 to or near to the desired reaction temperature. The one or plurality of heaters on disposable 1 can be configured in a closed loop using feedback from the temperature measurements from the one or plurality of temperature sensors on disposable 1 to keep the reaction temperature of reaction 35 at or near the desired reaction temperature.

In some chemical reactions 35, a precise amount of a critical reagent must be dispensed. The variable dwell time through filter 2 or filter module 71 can preclude placing critical reagent in the filter 2 or filter module 71. Dry critical reagent can be dispensed and dried on the surface of the photodetector 8 or surface 11 or inside well 19. Dry critical reagent can be placed and dried on the surface of the protrusion 50 that can contact the filtrate 24 or plasma 17 in well 19. Dry critical reagent can be placed and dried on the surface 201 of the lens 51 that contact the filtrate 24 or plasma 17 in well 19. Critical reagents can include magnetic particles. Critical reagent can be placed wet using contact dispense or print dispense. The amount of critical reagent dispensed can accurate to within 10%, 7%, 5%, 4%, 3%, 2%, 1% or 0.5%.

### System Integration

Disposable 1 can comprise a housing 44. Housing 44 can comprise a top housing 91 and a bottom housing 92 that snap or press fit together. Top housing 91 can have one or a plurality of posts 93 that can slot into one or a plurality of holes 94 in the bottom housing 92. Posts 93 can extend through PCB 3 via through-holes 96 in PCB 3. Posts 93 can register top housing 91 to PCB 3 in one, two or three dimensions. Post 93 can have a foot 95 to register top housing 91 to PCB 3 in the z-axis. Posts 93 can be concentric to and similar in diameter with through-holes in PCB 3 to register top housing 91 to PCB 3 in the x-y plane. Posts 93 can friction fit into holes in bottom housing 92.

Top housing 91 can have an inlet 66. Inlet 66 can accept whole blood 16, plasma 17 or sample 18. The top Inlet 66 can be an opening in top housing 91. The bottom of inlet 66 or 6 sample tool 65 can be in proximity to or contact filter 2 or filter module 71. Whole blood 16, plasma 17 or sample 18 in inlet 66 or sample tool 65 can contact one or a plurality of filters 2 or filter modules 71. Whole blood 16, plasma 17 or sample 18 in inlet 66 or sample tool 65 can flow to one or a plurality of filters 2 or filter modules 71. Inlet 66 or sample tool 65 can be fluidically connected to one or a plurality of filter 2 or filter module 71. Inlet 66 or sample tool 65 can be in proximity to or contact surface 11, PCB3 or tape 10. The bottom of Inlet 66 or sample tool 65 can crush one or a plurality of filter 2 or filter module 71. Inlet 66 or sample tool 65 can apply pressure on one or a plurality of filter 2 or filter module 71. The amount inlet crushes filter 2 or filter module 71 can be determined by the insertion of post 93 in hole 94. The force applied by inlet 66 on filter 2 or filter module 71 can be determined by the insertion of post 93 in hole 94. Inlet 66 or sample tool 65 can crush one or a plurality of prefilter 59 or 17 filter module 71 to ensure the flow of whole blood 16, plasma 17 or sample 18 in inlet 66 or sample tool 65 to one or a plurality of filter 2 or filter module 71. Inlet 66 or sample tool 65 can contact prefilter 59 of filter module 71 and crush filter 2 of filter module 71. Filter 2 of filter module 71 can be softer than prefilter 59 of filter module 71. Inlet 66 or sample tool 65 can contact and crush prefilter 59 of filter module 71. Filter 2 of filter module 71 can be harder than prefilter 59 of filter module 71. Inlet 66 can be separate from top housing 91. Inlet 66 or sample tool 65 can be a capillary to collect whole blood 16, plasma 17 or sample 18. Inlet 66 or sample tool 65 can be inserted into an opening in top housing 91. Inlet 66 or sample tool 65 can be manufactured from a hydrophilic polymer such as cellulose acetate or PMMA. Inlet 66 or sampling tool 65 can be hydrophilically coated. The inner diameter of inlet 66 or sample tool 65 can be more than 0.5 mm, 1 mm, 2 mm, 3 mm, 4 mm, or 5 mm. Inlet 66 can accept a sampling tool 65. Sampling tool 65 can be inserted into inlet 66. Sampling tool 65 can be a pipette, a pipette tip or a capillary. When inserted into inlet 66, sampling tool 65 can be fluidically connected to one or a plurality of filter 2 or filter module 71. Sampling tool 65 can have a hash mark indicating the minimum sample required. Sample tool 65 can be a transparent capillary. Sample tool 65 can have a flow stop feature to avoid overfill.

### Sensor Integration

Multiple types of sensors can be integrated into PCB 3. The multiple types of sensors can include general chemistry sensors, immuno-assay sensors, nucleic acid sensors, electrochemical sensors, coagulation sensors, or general sample indication sensors. The top exposed surface of an electrochemical IC or the top exposed surface of a magnetic sensing IC 83 can be planar with surface 11 or PCB 3. One or a plurality of IC 9, one or a plurality of electrochemical IC, one or a plurality of magnetic sensing IC 83 can be inserted in a single opening in PCB 3 and planarized with epoxy. One or a plurality of IC 9, one or a plurality of electrochemical IC, one or a plurality of magnetic sensing IC 83 can be inserted in a plurality opening in PCB 3 and planarized with epoxy. Each IC can be inserted into a dedicated opening in PCB 3. All the exposed ICs planar with PCB 3 can be wirebonded to PCB 3. All the ICs can be planar with PCB 3 to within 100 μm, 50 μm, 25 μm, 10 μm, 5 μm, 3 μm, 2 μm or 1 μm.

Disposable 1 can also integrate strip based electrochemical sensors. A strip based electrochemical sensor can detect glucose, creatinine, lactate or other indications. A strip based electrochemical sensor can be attached to PCB 3 with adhesive. Wirebonds can electrically connect the electrical leads on a strip based electrochemical sensor to pads on a PCB 3. Disposable 1 can contain the electronics to interface with a strip based electrochemical sensor. Disposable 1 can contain an ammeter, voltmeter and power management system to measure an analyte using a strip based electrochemical sensor mounted on PCB 3. Disposable 1 can store the calibration information for a lot of strip based electrochemical sensor. Inlet 66 can fluidically connect to the inlet on one or more strip based electrochemical sensor. The strip based electrochemical sensor can detect an analyte in whole blood. Strip based electrochemical sensors can be fluidically connected to filter 2 wherein the strip based electrochemical sensor analyzes plasma 17 from filter 2.

Disposable 1 can be circular to integrate multiple types of sensors for multiple types of analytes. One or a plurality of sensors can collect whole blood from the same inlet 66. A plurality of sensors can be arranged in a circle around a common inlet 66.

A plurality of printed circuit boards connected to different sensors can be mounted or connected to surface 11 or PCB 3. A common inlet 66 can fluidically connect to a plurality of printed circuit boards through capillary action. A central capillary in inlet 66 can split and turn 90° into a plurality of capillaries that deliver sample to a plurality of sensors integrated on one or a plurality of PCBs.

FIG. 1 presents a cross-sectional side view of disposable 1 that can comprise a filter 2, a surface 11 and a spectrophotometer 15. Filter 2 can be mounted on top of surface 11 using tape 10. Surface 11 can be the surface of PCB 3. LED cluster 130 can be mounted on PCB 3. Heater 152 and non-volatile memory 153 can be mounted on PCB 3. AOW 4 can be mounted on top of surface 11 using tape 10. Surface 11 can be hydrophilic. Surface 11 can be capable of fluidically connecting filter 2 to well 19, wherein plasma 17 can flow on surface 11 across gap 12 and into capillary 22. IC 9 can integrate photodetector 8. IC 9 can be incorporated into surface 11. Reflector 6 can contain an input lens 58 that can collect light of a plurality of single optical frequencies from LED cluster 130. Reflector 6 can contain optical elements 28 and 29 to redirect light of a plurality of single optical frequencies from LED cluster 130 into well 19 and onto photodetector 8. Protrusion 50, lens 51 or surface 201 can release dissolved critical reagent 160 into plasma 17 in well 19. Due to the small volume of well 19, dissolved critical reagent 160 can take less than 1 second, 10 seconds, 30 seconds, 1 minute, 2 minutes, 3 minutes, 5 minutes, 10 minutes, 15 minutes or 30 minutes to diffuse uniformly throughout well 19. Heater 152 can work in conjunction with a heater on IC 9. Heater 152 can provide coarse heating control and the heater in IC 9 can provide fine heating control. Heater 152 and a heater in IC 9 can heat simultaneously to heat up disposable 1 more rapidly. Heater 152 and the heater in the IC 9 can be pulse width modulated. Heater 152 on PCB 2, the heater in the IC 9 and the heater in reader 100 can be configured to maintain a steady temperature of the plasma 17 in well 19. A temperature sensor can be integrated in IC 9. A temperature sensor can be integrated on PCB 3. A temperature sensor can be integrated in reader 100. The temperature sensor can be used to modulate heater 152 or the heater in the IC 9

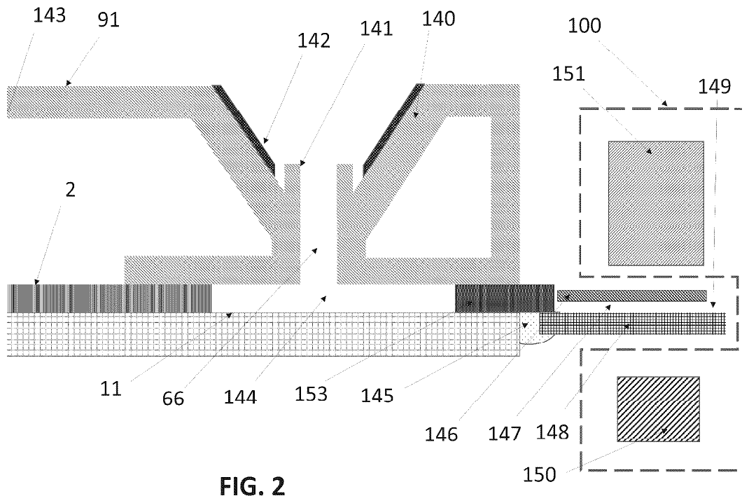

FIG. 2 presents the cross-sectional side view of the blood analysis system that can consist of disposable 1 and a reader 100. Disposable 1 can consist of a passive sample preparation system. The passive sample preparation system can extract plasma 17 from whole blood 16 without the use of active pressure, pumps or valves. The passive sample preparation system can consist of a hydrophobic pump, a filter and a well. Inlet 66 can be hydrophilic and promote the flow of whole blood from cuvette 140 onto filter 2 or filter module 71.

A passive sample preparation system can consist of a whole blood sample 16 in an inlet cuvette 14, a hydrophobic portion 142 of the inlet cuvette that repels the cellular and plasma components of the whole blood 16, a hydrophilic inlet capillary 66 below the inlet cuvette 140 a plasma separation filter 2 mounted on a surface 11, and a well 19 filled with plasma 17 mounted on the surface 11. The inlet cuvette 140 can be fluidically connected to the well 19 through the inlet capillary 66, the plasma separation filter 2 and the surface 11. The hydrophobic portion 142 can apply pressure on the whole blood 16 in the inlet cuvette 140. The cellular components of whole blood 16 can be blocked by the filter 2, while the plasma components of whole fill the well 19 to the top. The top of well 19 can be coated with a hydrophobic material to avoid plasma overflowing from the hydrophobic pump pressure. Well 19 can be manufactured of a hydrophobic material and the inside of well 19 can be coated with a hydrophilic material.

The hematology system can consist of a bottom hematology slide 148, a top hematology slide 146, a hematology capillary 147, a hematology pad 153, a light source 151 and an imaging system 150. Light source 151 and an imaging system 150 can be integrated in reader 100. A second inlet 149 can be fluidically connected to the hematology capillary 147. A second inlet 149 can permit other types of samples to be introduced and analyzed by the hematology system. Other types of samples can include urine, feces, swabs, elutions and other aqueous samples. 22

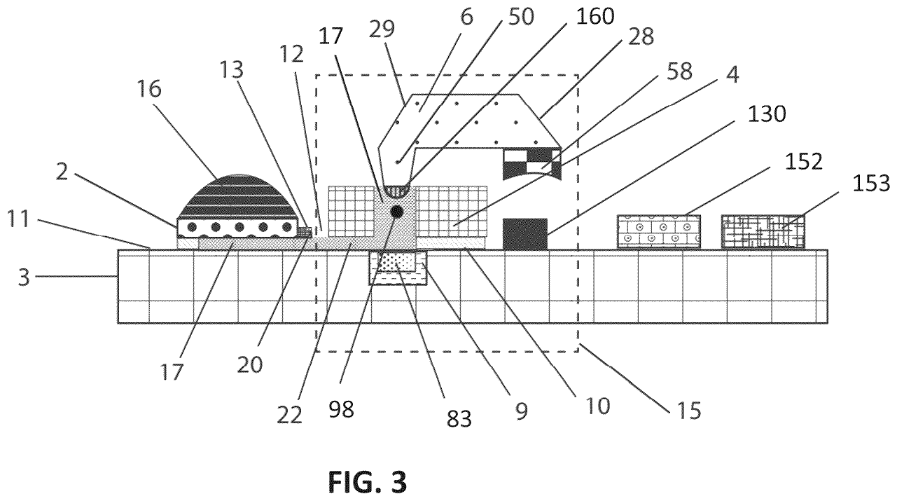

FIG. 3 presents the cross-sectional side view of magnetic sensing IC 83 that can be integrated on IC 9. Magnetic particle 98 can be dried in the dry critical reagents on the surface of protrusion 50. Magnetic particle 98 can be released into and be suspended in plasma 17 in well 19 when the dry critical reagents on the surface of protrusion 50 become dissolved critical reagents 160. The magnetic particle 98 can incubate with the target analyte in plasma 17 and can draw or concentrate the target analyte onto the surface of magnetic sensing IC 83 through sedimentation. Magnetic sensing IC 83 can have an array of magnetic particle sensors. The magnetic particle sensors can be photodetectors or optical sensors that can detect the magnetic particle 98 on its surface. Light from LED cluster 130 can be used to illuminate the surface of the magnetic sensing IC 83. Magnetic particle 98 can cast a shadow on surface 11 above an optical sensor. The shadow cast by magnetic particle 98 can be detected by an optic sensor in magnetic sensing IC 83. Current carrying conductors placed laterally to the optical sensors can pull the magnetic particle 98 away from above the optical sensor. The magnetic force pulling on magnetic particle 98 can be chosen to remove the non-specifically bound magnetic particles but not the specifically bound magnetic particles. The number of magnetic particles 6 as detected by the magnetic particle sensors can correspond to the concentration of the immuno-assay biomarker in plasma 17.

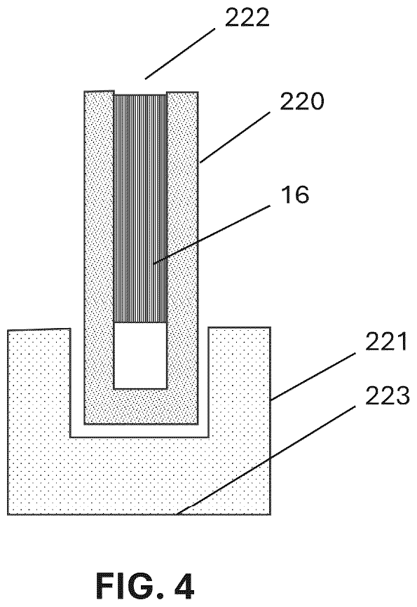

FIG. 4 is a cross-sectional side view of a sample pipette 220 that can draw, collect or hold whole blood 16 from a fingerstick. To facilitate self-collection, pipette 220 can be placed vertically or near vertically with the capillary opening 222 that can accept whole blood 16 at the top. Pipette 220 or a stand 221 can have a flat bottom 223 that can orient pipette 220 in a vertical or near vertical position. Flat bottom 223 can be placed on or above a horizontal 13 testing surface like a counter or desk. Pipette 220 can be inserted or placed into stand 221. Stand 221 can have a notch, grove or opening that can hold pipette 220 vertically or near vertically. Stand 221 or pipette 220 can be placed on or above a flat horizontal testing surface. The disposable 1 and reader 100 can be placed on the flat horizontal testing surface. Pipette 220 can fit loosely or tightly in stand 221. Pipette 220 or stand 221 can have a tapered construction that can enable easy insertion and/or friction fit. Stand 221 can be single-use or re-usable. Pipette 220 can have a fluid sto or an auto-fill feature wherein pipette 220 cannot accept whole blood 16 beyond a metered, pre-determined volume. Pipette 220 can meter whole blood volume 16. The volume of whole blood 16 metered by pipette 220 can be higher than the minimum whole blood volume required by disposable 1. Users can lance their finger and expel whole blood 16 into pipette 220 in stand 221. Pipette 220 can be coated with anti-coagulants to prevent clotting while whole blood 16 is drawn. Pipette 220 can have a bulb or plunger to expel whole blood 16 into inlet cuvette 140. Pipette 220 can expel whole blood 16 into inlet cuvette 140. Pipette caneb hydrophilic to pull whole blood 16 through capillary action.

I claim:

1. A passive sample preparation system comprising:
an inlet cuvette within which is a whole blood sample comprising cellular components and plasma components, and wherein the whole blood sample, and wherein the inlet cuvette has a hydrophobic portion, wherein the hydrophobic portion is configured to repel the cellular and plasma components of the whole blood sample;
a hydrophilic inlet capillary below the inlet cuvette;
a plasma separation filter mounted on a surface; and
a well filled with plasma mounted on the surface;
wherein the inlet cuvette is fluidically connected to the well through the inlet capillary, the plasma separation filter and the surface.
wherein the hydrophobic portion applies pressure on the whole blood in the inlet cuvette;
wherein the cellular components of the whole blood sample are blocked by the filter; and
wherein the plasma components of the whole blood sample fill the well to the top.

2. The device of claim 1, wherein the hydrophobic portion of inlet cuvette is coated with a hydrophobic material.

3. The device of claim 1, wherein the inlet capillary is coated with a hydrophilic material.

4. The device of claim 1, wherein the surface is coated with a hydrophilic material.

5. The device of claim 1, wherein the top of the well is coated with a hydrophobic material.

6. The device of claim 1, wherein an inlet stand-off can be a protrusion from the inlet cuvette.

7. The device of claim 1, further comprising a pin pressing the filter against the surface.

8. The device of claim 7, wherein the pin has a fluid-stop feature.
